(19) United States
(12) Patent Application Publication
(10) Pub. No.: US 2026/0106372 A1
(43) Pub. Date: Apr. 16, 2026

(54) ANTENNA MODULE HAVING MICROSTRIP-TO-WAVEGUIDE TRANSITION STRUCTURE

(71) Applicant: LG ELECTRONICS INC., Seoul (KR)

(72) Inventors: Woocheol CHOI, Seoul (KR); Ilnam CHO, Seoul (KR); Byungwoon JUNG, Seoul (KR); Youngtaek HONG, Seoul (KR)

(73) Assignee: LG ELECTRONICS INC., Seoul (KR)

(21) Appl. No.: 19/104,984

(22) PCT Filed: Sep. 26, 2022
(86) PCT No.: PCT/KR2022/014319

§ 371 Date: Feb. 19, 2025

(51) Int. Cl. H01Q 3/26; H01P 3/08; H01P 5/107; H01Q 1/38

(52) U.S. Cl. CPC H01Q 3/26; H01P 3/08; H01P 5/107; H01Q 1/38

(57) ABSTRACT

An antenna module comprises: a waveguide having an opening region; a transmission line comprising a signal pattern, a first ground pattern, and a second opening region; a conductive surface having a plurality of conductive patterns arranged in one axial direction and the other axial direction; and a via structure for perpendicularly connecting a second ground pattern and the plurality of conductive patterns of the conductive surface. A first length in one axial direction of a region where the conductive surface is arranged may be formed so as to be at least two times longer than a second length in one axial direction of the opening region. A first width in the other axial direction of the region where the conductive surface is arranged may be formed so as to be at least two times wider than a second width in the other axial direction of the opening region.

### TECHNICAL FIELD

The specification relates to an antenna module and an electronic device including the same. One particular implementation relates to an antenna module having a microstrip-to-waveguide transition structure, and an electronic device including the same.

### BACKGROUND ART

As functions of electronic devices diversify, the electronic devices may be implemented as image display devices such as multimedia players having complex functions, for example, playing music or video files, playing games, receiving broadcasts, and the like.

An image display device is a device for reproducing (playing) image contents. Image display devices receive images (videos) from various sources and reproduce the received images. Image display devices are implemented as various devices such as personal computers (PC), smart phones, tablet PCs, laptop computers, TV sets, and the like. An image display device, such as a smart TV, may provide an application for providing web contents, such as web browsers.

Communication module design technologies for supporting ultra-high speed and large capacity communications are rapidly evolving together with rapid development of 5th/6th generation (5G/6G) mobile communication. Accordingly, the demand for the development of transmitters and receivers in millimeter wave and terahertz bands is increasing significantly.

In some embodiments, in addition to WiFi wireless interfaces, ultra-high-speed wireless interfaces using a terahertz (THz) band may be considered as interfaces for communication services between electronic devices. When using the ultra-high-speed wireless interface, a terahertz band as well as a millimeter wave (mmWave) band may be used for high-speed data transmission between the electronic devices.

A terahertz (THz) band refers to a frequency band between 100 GHz and 10 THz, and generally, as the frequency band increases, a wider communication bandwidth may be used, making it suitable for the ultra-high-speed communications required for 6G. The terahertz band is considered as a candidate frequency band of 6G communication, which aims to achieve a data transmission speed of 1 Tbps (speed of transmitting one trillion bits per second), which is up to 50 times faster than the data transmission speed (up to 20 Gbps) of 5G communication. However, as the frequency band gets higher, great path loss is caused, resulting in shorter radio wave propagation distances due to the characteristics of radio waves. Therefore, an advanced beamforming technology is required to integrate numerous antennas inside a communication system and transmit and receive radio waves in a specific direction.

As an operating frequency gets higher in 6G communication, the loss of a substrate gradually increases, so waveguide-type antennas may be used in the design of RF communication modules that require high output and low loss characteristics. In this regard, the design of a microstrip-to-waveguide transition structure is required to convert signals of a transceiver circuit implemented on a PCB substrate into signals in a waveguide.

However, in the microstrip-to-waveguide signal transition structure, less signal reflection loss and high signal conversion efficiency are needed. In this regard, the microstrip-to-waveguide transition structure may design a signal conversion portion in the form of a cavity that extends a waveguide end by λ/4. However, there are problems that an additional design space is required for the signal conversion portion, and signal transfer has frequency-dependent characteristics due to the length of the signal conversion portion.

### DISCLOSURE OF INVENTION

### Technical Problem

One aspect of the specification is to solve the aforementioned problems and other drawbacks. Another aspect is to provide an antenna module operating in a terahertz band for 6G communication and an electronic device including the same.

Still another aspect is to provide a microstrip-to-waveguide transition structure capable of improving signal conversion efficiency by using a metamaterial-based artificial magnetic conductor.

Still another aspect is to provide a metamaterial-based attachable ultrathin microstrip-to-waveguide transition structure.

Still another aspect is to minimize changes in electrical characteristics of an antenna module due to an alignment error of a microstrip-to-waveguide transition structure.

### Solution to Problem

To achieve the above or other purposes, an antenna module according to an embodiment includes a waveguide configured to have an open area, a transmission line including a signal pattern, a first ground pattern, and a second open area; a conductive surface on which a plurality of conductive patterns are arranged in one axial direction and another axial direction; and a via structure configured to vertically connect the plurality of conductive patterns of the conductive surface and a second ground pattern. A first length in one axial direction of a region where the conductive surface is arranged may be formed to be at least twice longer than a second length in the one axial direction of the open area. A first width in the another axial direction of the region where the conductive surface is arranged may be formed to be at least twice wider than a second width in the another axial direction of the open area.

In an embodiment, the waveguide may be configured to have an open area at one end in a longitudinal direction such that a signal of a specific frequency band is transmitted. The waveguide may include radiation regions formed at another end in the longitudinal direction so that the signal is radiated.

In an embodiment, the antenna module may further include a first dielectric substrate arranged in the open area of the waveguide, and a second dielectric substrate arranged in an upper region of the first dielectric substrate. The transmission line may be formed on one surface of the first dielectric substrate. A second ground pattern may be formed on one surface of the second dielectric substrate. The conductive surface may include a plurality of conductive patterns arranged on another surface of the second dielectric substrate in the one axial direction and the another axial direction.

In an embodiment, an artificial magnetic conductor (AMC) including the plurality of conductive patterns may include a first slot pattern formed in an electric field direction of the signal, as the one axial direction, based on a center point to which the vertical via is connected; and a second slot pattern formed in a magnetic field direction of the signal, as the another axial direction, based on the center point to which the vertical via is connected. An inductance L may be induced to correspond to a current formed in the second ground pattern between adjacent vertical vias of the via structure. A capacitance Cg may be induced between the second slot patterns of the conductive patterns adjacent in the electric field direction, among the plurality of conductive patterns. A first capacitance Cp1 may be induced in the first slot pattern, and a second capacitance Cp2 may be induced in the second slot pattern. The resonant frequency fr of the AMC may be set as expressed in Mathematical Expression 3.

In an embodiment, one surface of the first dielectric substrate may be arranged to oppose the second dielectric substrate on which the conductive surface is formed. Another surface of the first dielectric substrate may be arranged to oppose the open area of the waveguide. A third ground pattern formed on the another surface of the first dielectric substrate may have a third open area formed to correspond to the open area of the waveguide.

In an embodiment, a first length of the open area of the waveguide in the one axial direction, a second length of the second open area of the transmission line in the one axial direction, and a third length of the third open area of the first dielectric substrate in the one axial direction may be formed identically. A first width of the open area of the waveguide in the another axial direction, a second width of the second open area of the transmission line in the another axial direction, and a third width of the third open area of the first dielectric substrate in the another axial direction may be formed identically. The one axial direction and the another axial direction may be formed in an electric field direction and a magnetic field direction of a signal transmitted through the waveguide.

In an embodiment, the antenna module may further include a second via structure configured to vertically connect the second ground pattern and the third ground pattern. A plurality of vertical vias constituting the second via structure may be configured to connect the first ground pattern and the third ground pattern in outer regions of the second open area and the third open area.

In an embodiment, the first ground pattern may be arranged spaced apart from the signal pattern on one side and another side of the signal pattern of the transmission line. One end of the signal pattern may be electrically connected to a transceiver circuit arranged on a third dielectric substrate that is arranged separately from the first dielectric substrate. The first ground pattern may be formed to surround another end of the signal pattern and the one side and the another side of the signal pattern. The another end of the signal pattern may be formed in the second open area, so that a signal transmitted from the transceiver circuit is transmitted into the waveguide and radiated through a radiation region of the waveguide.

In an embodiment, a unit cell of each of the plurality of conductive patterns may include: a conductive pattern formed in a circular shape to correspond to a circular shape of the vertical via constituting the via structure; a first slot pattern formed on the conductive pattern to be symmetrical to the vertical via in the one axial direction; and a second slot pattern formed on the conductive pattern to be symmetrical to the vertical via in the another axis direction. The first slot pattern may include a first sub-slot and a second sub-slot formed in upper and lower regions of the vertical via. The second slot pattern may include a third sub-slot and a fourth sub-slot formed in left and right regions of the vertical via.

In an embodiment, the first sub-slot through the fourth sub-slot may be formed with a first length through a fourth length in the one axial direction and the another axial direction. The first sub-slot through the fourth sub-slot may be formed with a first width through a fourth width in the one axial direction and the another axial direction. The first length through the fourth length may be set to a same length. The first width through the fourth width may be set to a same width.

In an embodiment, the first length through the fourth length may be smaller than a difference between a first radius of the conductive pattern and a second radius of a connection region of the vertical via connected to the conductive pattern.

In an embodiment, end portions of the first sub-slot to the fourth sub-slot, adjacent to the vertical via, may be formed in a semicircular shape. A third radius of the end portions of the first sub-slot to the fourth sub-slot having the semicircular shape may be smaller than the second radius of the vertical via. The first width to the fourth width of the first sub-slot to the fourth sub-slot may be smaller than the second radius of the vertical via.

In an embodiment, the conductive surface may include at least M unit cells arranged in the one axial direction, and at least N unit cells arranged in the another axial direction. Here, M may be greater than N.

In an embodiment, a first unit cell, a second unit cell, and a third unit cell, which are adjacent in the one axial direction, may include a first vertical via, a second vertical via, and a third vertical via, respectively. A first current path may be formed along a conductive pattern of the first unit cell, the first vertical via, the second ground pattern, the second vertical via, and a conductive pattern of the second unit cell. A second current path may be formed along a conductive pattern of the third unit cell, the third vertical via, the second ground pattern, the first vertical via, and the conductive pattern of the first unit cell. A first direction of the first current path and a second direction of the second current path may be opposite to each other.

In an embodiment, a first unit cell and a second unit cell, adjacent in the one axial direction, may be arranged spaced apart from each other by at least a first gap. The first unit cell and a fourth unit cell, adjacent in the another axial direction, may be arranged spaced apart from each other by at least a second gap.

In an embodiment, the first slot patterns of the first unit cell and the second unit cell in the one axial direction may be configured to be interconnected. The second slot patterns of the first unit cell and the fourth unit cell in the another axial direction may be configured to be interconnected.

In an embodiment, a size of the unit cell in the one axial direction and the another axial direction may be formed in a range of 10 um based on 380 um. The first unit cell and the second unit cell may be arranged spaced apart from each other in a range of 10 to 20 um in the one axial direction. The first unit cell and the second unit cell may be arranged spaced apart from each other in a range of 10 to 20 um in the another axial direction. The signal of the specific frequency band transmitted from the waveguide to the signal pattern of the transmission line may be a signal of a frequency band ranging from 158 GHz to 162 GHz.

According to another aspect of the disclosure, an electronic device includes: an array antenna module configured to perform beamforming by radiating a signal of a specific frequency band, and a transceiver circuit operably coupled to the array antenna module and configured to transmit the signal of the specific frequency band to the array antenna module. The array antenna module may include a waveguide including an open area; a transmission line including a signal pattern, a first ground pattern, and a second aperture region; a conductive surface on which a plurality of conductive patterns are arranged in one axial direction and another axial direction; and a via structure configured to vertically connect the plurality of conductive patterns of the conductive surface and the second ground pattern.

In an embodiment, the antenna module may include: a waveguide configured to have an open area at one end in a longitudinal direction so that the signal of the specific frequency band is transmitted, wherein the waveguide has radiation regions formed at another end in the longitudinal direction so that the signal is radiated; a first dielectric substrate arranged in the open area of the waveguide; a transmission line arranged in an upper region of the first dielectric substrate and including a signal pattern, a first ground pattern, and a second open area; a second dielectric substrate arranged in the upper region of the first dielectric substrate, wherein the second dielectric substrate includes a second ground pattern on one surface of the second dielectric substrate; a conductive surface arranged on another surface of the second dielectric substrate, and including a plurality of conductive patterns arranged in the one axial direction and the another axial direction.

In an embodiment, a first length in the one axial direction of a region where the conductive surface is arranged, may be at least twice longer than a second length in the one axial direction of the open area. A first width in the another axial direction of the region where the conductive surface is arranged may be formed to be at least twice wider than a second width in the another axial direction of the open area.

### Advantageous Effects of Invention

Hereinafter, technical effects of an antenna module having a microstrip-to-waveguide transition structure, and an electronic device having the same will be described.

According to an embodiment, ultra-high-speed 6G wireless communication based on a terahertz band may be enabled through an antenna module and an electronic device having the same.

According to an embodiment, signal conversion efficiency in a microstrip-to-waveguide transition structure may be improved by using a conductive surface structure of a metamaterials-based artificial magnetic conductor.

According to an embodiment, a height of a microstrip-to-waveguide transition structure may be minimized by providing a metamaterial-based attachable ultra-thin microstrip-to-waveguide transition structure.

According to an embodiment, a change in electrical characteristics of an antenna module due to an alignment error of a microstrip-to-waveguide transition structure may be minimized upon an occurrence of an alignment error of an AMC-based unit cell structure.

According to an embodiment, AMC-based unit cell structures may be formed in an arrangement structure in one axial direction and another axial direction, thereby providing a high-output, low-loss transmission structure in a millimeter wave band or higher.

Further scope of applicability of the disclosure will become apparent from the following detailed description. It should be understood, however, that the detailed description and specific examples, such as the preferred embodiments, are given by way of illustration only, because various changes and modifications within the technical idea and scope of the disclosure will be apparent to those skilled in the art.

### BRIEF DESCRIPTION OF DRAWINGS

FIG. 1 is a view of an example of an electromagnetic spectrum including millimeter wave and terahertz bands according to the specification.

FIG. 2 is a view of an example of a THz communication application according to the specification.

FIG. 3 is a view of examples of a communication system applied to the specification and devices performing wireless communications through the communication system.

FIG. 4 is a view of a configuration of wireless devices performing wireless communications according to the specification.

FIG. 5 is a view of an electronic device including a plurality of antenna modules and a plurality of transceiver circuit modules according to an embodiment.

FIG. 6A is a view of a configuration, in which a multi-layer circuit board having an array antenna module is connected to an RFIC, in relation to a THz band communication.

FIG. 6B is a view of a coupling structure between a multi-layer substrate and a main substrate according to embodiments.

FIG. 7A is a block diagram of a communication module that performs terahertz-based wireless communication of at least 100 GHz.

FIG. 7B is a side view of a microstrip-to-waveguide transition structure in a communication module performing the terahertz-based wireless communication of FIG. 7A.

FIGS. 8A and 8B are views of stacked structures of antenna modules having microstrip-to-waveguide transition structures.

FIGS. 9A and 9B are side perspective views of the microstrip-to-waveguide transition structures of FIGS. 8A and 8B, and internal electric field distributions in the microstrip-to-waveguide transition structures.

FIG. 10A is a view of a structure in which unit cell structures are arranged in horizontal and vertical directions on a conductive surface having the form of an artificial magnetic conductor of FIG. 8B.

FIG. 10B is a view of a structure of another surface and side surface of the conductive surface having the form of the artificial magnetic conductor of FIG. 8B.

FIG. 11A is a side perspective view of a plurality of unit cell structures, forming a conductive surface, formed on a substrate.

FIG. 11B is a view of a structure in which the plurality of unit cell structures of FIG. 11A are arranged on an open area of a waveguide.

FIG. 12 is a view of an equivalent circuit of the conductive surface having the artificial magnetic conductor of FIG. 10A.

FIGS. 13A and 13B are views of a structure in which the unit cell structures of the artificial magnetic conductor of FIG. 10A are formed in the vertical and horizontal directions, and an equivalent circuit of the structure.

FIG. 13C is a view of an equivalent circuit showing an input impedance based on the conductive surface of the artificial magnetic conductor of FIGS. 13A and 13B.

FIG. 14 is a view of the electric field distribution of the microstrip-to-waveguide transition structure of FIGS. 9A and 9B.

FIG. 15A compares reflection loss and insertion loss of the microstrip-to-waveguide transition structures of FIGS. 9A and 9B.

FIG. 15B is a view of characteristic impedance and phase response curves of the microstrip-to-waveguide transition structure of FIG. 9B.

FIG. 15C is a view of characteristic impedance and phase response curves according to changes in diameter in a unit cell structure of an artificial magnetic conductor.

FIG. 16A compares current distributions formed on conductive patterns of unit cell structures according to presence or absence of a slot structure.

FIG. 16B compares characteristic impedance values according to the shapes of the unit cell structures of FIG. 16A.

FIG. 17A is a view of a structure in which unit grids of a conductive surface are offset in vertical and horizontal directions with respect to an open area of a waveguide.

FIGS. 17B and 17C are views of changes in reflection coefficient and transmission coefficient characteristics according to changes in offset interval in an x-axis direction and a y-axis direction.

FIG. 18A is a view of a transition structure in which unit cell structures within a conductive surface 1150 form 5×7 array and 3×5 array.

FIG. 18B is a view of reflection coefficient and transmission coefficient characteristics of transition structures with 7×9 array, 5×7 array, and 3×5 array.

FIG. 19A is a view of a structure in which an antenna module having a first type antenna and a second type antenna as array antennas is arranged in an electronic device.

FIG. 19B is an enlarged view of a plurality of array antenna modules.

FIG. 20 is a view of antenna modules coupled by different coupling structures at specific positions of an electronic device according to embodiments.

### MODE FOR THE INVENTION

A description will now be given in detail according to one or more embodiments disclosed herein, with reference to the accompanying drawings. For the sake of a brief description with reference to the drawings, the same or equivalent components may be provided with the same reference number, and the description thereof will not be repeated. Suffixes “module” and “unit” used for components used in the following description are merely intended for easy description of the specification, and each suffix itself is not intended to give any special meaning or function. In describing the embodiments disclosed herein, moreover, the detailed description will be omitted when a specific description for publicly known technologies to which the disclosure pertains is judged to obscure the gist of the disclosure. The accompanying drawings are used to help easily understand the technical idea of the disclosure and it should be understood that the idea of the disclosure is not limited by the accompanying drawings. The idea of the present disclosure should be construed to extend to any alterations, equivalents, and substitutes besides the accompanying drawings.

It will be understood that although the terms first, second, and the like may be used herein to describe various elements, these elements should not be limited by these terms. These terms are generally only used to distinguish one element from another.

It will be understood that when an element is referred to as being “connected with” another element, the element may be connected with the another element or intervening elements may also be present. In contrast, when an element is referred to as being “directly connected with” another element, there are no intervening elements present.

The singular forms are intended to include the plural forms as well, unless the context clearly indicates otherwise.

The term “include” or “has” as used herein should be understood that it is intended to indicate the existence of a feature, a number, a step, an element, a component, or a combination thereof disclosed in the specification, and it may also be understood that the existence or additional possibility of one or more other features, numbers, steps, elements, components, or combinations thereof are not excluded in advance.

The following technology may be used in various wireless access systems, such as CDMA, FDMA, TDMA, OFDMA, SC-FDMA, and the like. The CDMA may be implemented as wireless technology, such as universal terrestrial radio access (UTRA) or CDMA2000. The TDMA may be implemented as wireless technology, such as global system for mobile communications (GSM)/general packet radio service (GPRS)/enhanced data rates for GSM evolution (EDGE). The OFDMA may be implemented as wireless technology, such as institute of electrical and electronics engineers (IEEE) 802.11 (Wi-Fi), IEEE 802.16 (WiMAX), IEEE 802-20, evolved UTRA (E-UTRA), or the like. The UTRA is part of the universal mobile telecommunications system (UMTS). Third generation partnership project (3GPP) long term evolution (LTE) is a part of evolved UMTS (E-UMTS) that uses E-UTRA, and LTE-advanced (LTE-A)/LTE-A pro is an evolved version of 3GPP LTE. 3GPP new radio or new radio (NR) access technology is an evolved version of 3GPP LTE/LTE-A/LTE-A pro. 3GPP 6G may be an evolved version of 3GPP NR.

### Overall 6G System

6G (wireless communication) systems are aimed at (i) very high data rates per device, (ii) a very large number of connected devices, (iii) global connectivity, (iv) very low latency, (v) reduced energy consumption for battery-free IoT devices, (vi) ultra-reliable connectivity, and (vii) connected intelligence with machine learning capabilities. The vision of 6G system may be divided into four aspects: intelligent connectivity, deep connectivity, holographic connectivity, and ubiquitous connectivity, and the 6G system may satisfy the requirements as shown in Table 1 below. That is, Table 1 shows an example of the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/h |
| Satellite integration | Fully |
| AI | Fully |
| Autonomous vehicle | Fully |
| XR | Fully |
| Haptic Communication | Fully |

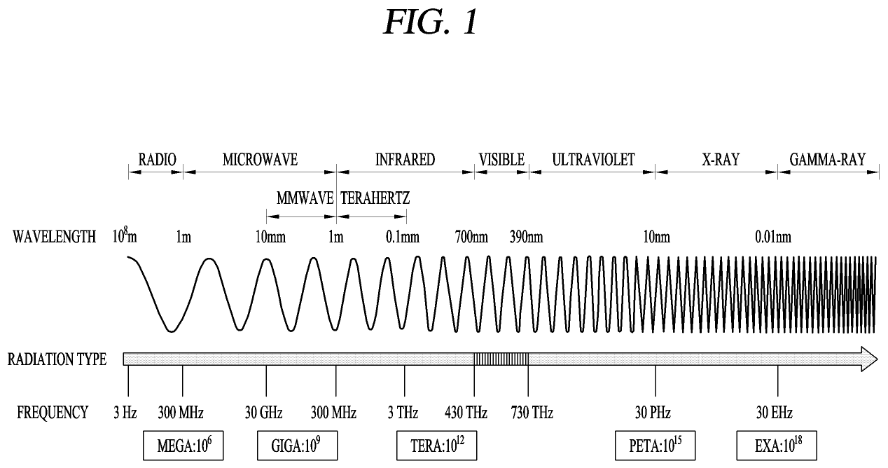

6G systems may have key factors, such as enhanced mobile broadband (eMBB), ultra-reliable low latency communications (URLLC), massive machine-type communication (mMTC), AI integrated communication, tactile Internet, high throughput, high network capacity, high energy efficiency, low backhaul and access network congestion, and enhanced data security. FIG. 1 is a view of an example of a communication structure that may be provided in a 6G system.

It is anticipated that the 6G system has simultaneous wireless communication connectivity which is 50 times higher than the 5G wireless communication system. URLLC which is the key feature of 5G will be even more important technology by providing a smaller end-to-end latency than 1 ms in the 6G communication. In the 6G system, volume spectrum efficiency will be even more excellent unlike area spectrum efficiency frequently used.

### Terahertz (THz) Communication

The data rate may be increased by increasing a bandwidth. This may be performed by using sub-THz communication with a wide bandwidth, and applying an advanced massive MIMO technology. A THz wave, also known as a radiation of millimeters or less generally shows a frequency band between 0.1 THz and 10 THz having a corresponding wavelength ranging from 0.03 mm to 3 mm. A band range of 100 GHz to 300 GHz (sub-THz band) is regarded as a primary part of the THz band for cellular communication. A 6G cellular communication capacity increases when the sub-THz band is added to a mmWave band. A band range of 300 GHz to 3 THz in a defined THz band is present in an infrared (IR) frequency band. The band range of 300G Hz to 3 THz is a part of a wideband, but is present on a boundary of the wideband, and is present just behind an RF band. Therefore, the band range of 300G Hz to 3 THz shows a similarity to the RF.

In this regard, FIG. 1 is a view of an example of an electromagnetic spectrum including millimeter wave and terahertz bands according to the specification.

Referring to FIG. 1, a THz wave may be located between a radio frequency (RF)/millimeter wave (mm) and an IR band, and (i) may have high straightness and enable beam convergence by virtue of better transmission of a non-metallic/non-polarizable material than visible light/infrared rays, and a shorter wavelength than the RF/millimeter wave. Further, photon energy of the THz wave is harmless to a human body because the photon energy is only several meV. A frequency band which is expected to be used for THz wireless communication may be a D-band (110 GHz to 170 GHz) or an H-band (220 GHz to 325 GHz) having small less wave loss by molecular absorption in the air. The standardization of the THz wireless communication is discussed by the IEEE 802.15 THz working group, along with 3GPP, and a standard document issued by the IEEE 802.15 Task Group (TG3d, TG3e) may embody or supplement the contents described in this specification.

The THz wireless communication may be applied in wireless cognition, sensing, imaging, wireless communication, THz navigation, and the like. Main features of the THz communication may include (i) a bandwidth widely usable to support a very high data rate, and (ii) a high path loss occurred at a high frequency (a high directional antenna is essential). A narrow beam width generated by the high directional antenna reduces interference. A small wavelength of a THz signal may allow even more antenna elements to be integrated into a device and a BS which operate in this band. Through this, an advanced adaptive arrangement technology capable of overcoming range limitations may be used.

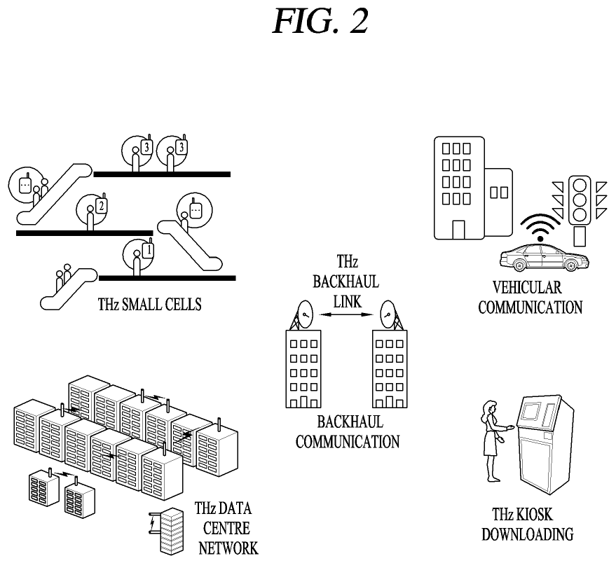

FIG. 2 is a view of an example of a THz communication application. As illustrated in FIG. 2, a THz wireless communication scenario may be categorized into a macro network, a micro network, and a nanoscale network. In the macro network, the THz wireless communication may be applied to a vehicle-to-vehicle connection and a backhaul/fronthaul connection. In the micro network, the THz wireless communication may be applied to an indoor small cell, a fixed point-to-point or multi-point connection, such as wireless connection in a data center, and near-field communication, such as kiosk downloading.

Table 2 below is a table that shows an example a technology which may be used in the THz wave.

TABLE 2

| | |
|---|---|
| Transceivers Device | Available immature, UTC-PD, RTD, and SBD |
| Modulation and | Low order modulation techniques (OOK, QPSK), |
| Coding | ┐ LDPC, Reed Soloman, Hamming, Polar, Turbo |
| Antenna | Omni and Directional, Phased array with low |
| | number of antenna elements |
| Bandwidth | 69 GHz (or 23 GHz) at 300 GHz |
| Channel models | Partially |
| Data rate | 100 Gbps |
| Outdoor deployment | No |
| Free space loss | High |
| Coverage | Low |
| Radio Measurements | 300 GHz indoor |
| Device size | Few micrometers |

### Optical Wireless Technology

An OWC technology has been planned for 6G communication in addition to RF-based communication for all available device-to-access networks. The network is connected to a network-to-backhaul/fronthaul network connection. The OWC technology is already used after a 4G communication system, but may be more widely used for meeting the requirements of a 6G communication system. The OWC technologies, such as light fidelity, visible light communication, optical camera communication, and FSO communication based on a wideband are already well known. The optical wireless technology-based communication may provide very high data speed, low latency time, and safe communication. LiDAR may also be used for super-ultra high resolution 3D mapping in the 6G communication based on the wideband.

### FSO Backhaul Network

Transmitter and receiver features of an FSO system are similar to the features of an optical fiber network. Therefore, data transmission of the FSO system is similar to that of the optical fiber system. Therefore, the FSO may be an excellent technology that provides a backhaul connection in the 6G system together with the optical fiber network. When the FSO is used, very long-distance communication is enabled even at a distance of 10,000 km or more. The FSO supports a massive backhaul connection for remote and non-remote regions, such as the sea, the space, the underwater, and an isolated island. The FSO also supports a cellular BS connection.

### Massive MIMO Technology

One of core technologies for enhancing spectrum efficiency is to apply a MIMO technology. When the MIMO technology is enhanced, the spectrum efficiency is also enhanced. Therefore, the massive MIMO technology may be important in the 6G system. The MIMO technology uses a plurality of paths, and thus a multiplexing technology and a beam generation and operating technology suitable for the THz band should also be considered importantly so that a data signal is transmitted through one or more paths.

### Blockchain

The blockchain will become an important technology for managing massive data in a future communication system. The blockchain is a form of a distributed ledger technology, and the distributed ledger is a database distributed in numerous nodes or computing devices. Each node replicates and stores the same ledger copy. The blockchain is managed by a P2P network. The blockchain may be present without being managed by a centralized agency or server. Data of the blockchain is jointly collected and constituted by blocks. The blocks are connected to each other, and protected by using encryption. The blockchain fundamentally perfectly complements massive IoT through enhanced interoperability, security, personal information protection, stability, and scalability. Therefore, the blockchain technology provides various functions, such as inter-device interoperability, massive data traceability, autonomous interactions of different IoT systems, and massive connection stability of the 6G communication system.

### 3D Networking

The 6G system supports user communication of vertical scalability by integrating ground and aerial networks. A 3D BS may be provided through a low-orbit satellite and a UAV. A 3D connection is quite different from the existing 2D network when a new dimension is added in terms of an altitude and a related degree of freedom.

### Quantum Communication

In the context of the 6G network, unsupervised reinforcement learning of the network is promising. The supervised learning scheme is not allowed to designate a label in a vast amount of data generated in the 6G. The labeling is not required in the unsupervised learning. Therefore, the technology may be used for autonomously constructing a complicated network expression. The network may be operated by a true autonomous scheme when the reinforcement learning and the unsupervised learning are combined.

### Unmanned Aerial Vehicle

The unmanned aerial vehicle (UAV) or a drone will become an important element in the 6G wireless communication. In most cases, a high-speed data wireless connection is provided by using a UAV technology. A BS entity is installed in the UAV to provide cellular connection. The UAV has a specific function which may not be seen in a fixed BS infrastructure, such as easy deployment, strong visible-line link, the degree of freedom in which mobility is controlled. During emergencies, such as natural disasters, the arrangement of a ground communication infrastructure is not enabled to be economically realized, and sometimes services may not be provided in volatile environments. The UAV may easily handle these situations. The UAV will become a new paradigm of a wireless communication field. This technology facilitates three basic requirements of the wireless network, i.e., eMBB, URLLC, and mMTC. The UAV may also support various purposes, such as network connectivity enhancement, fire sensing, disaster emergency services, securing and monitoring, pollution monitoring, parking monitoring, accident monitoring, and the like. Therefore, the UAV technology is recognized as one of the most important technologies for the 6G communication.

### Cell-Free Communication

The close integration of multiple frequencies and heterogeneous communication technologies is very important in the 6G system. As a result, a user may move smoothly from a network to another network without the need to create any manual configuration in a device. A best network is automatically selected in an available communication technology. This will break the limitation of a cell concept in wireless communication. Currently, user movement from one cell to another cell causes too many handovers in the network, and causes handover failures, handover latency, data loss, and pingpong effects. 6G cell-free communication will overcome all of the problems, and provide better QoS. The cell-free communication will be achieved through different heterogeneous radios of multi-connectivity and multi-tier hybrid technologies and devices.

### Wireless Information and Energy Transmission Integration

WIET uses the same field and wave as the wireless communication system. In particular, the sensor and the smartphone may be charged by using wireless power transmission during communication. The WIET is a promising technology for extending the lifespan of a battery charging wireless system. Therefore, a device without a battery may be supported in the 6G communication.

### Integration of Sensing and Communication

An autonomous wireless network is a function to continuously sense an environmental state which dynamically changes, and exchange information between different nodes. In the 6G, the sensing may be closely integrated with communication to support an autonomous system.

### Integration of Access Backhaul Networks

In the 6G, the density of the access network may be enormous. Each access network is connected by the backhaul network, such as the optical fiber and the FSO network. To cope with a very larger number of access networks, there may be a close integration between the access and the backhaul network.

### Hologram and Beamforming

The beamforming is a signal processing procedure of adjusting an antenna array to transmit a radio signal. The beamforming is a sub-set of a smart antenna or advanced antenna system. The beamforming technology has several advantages, such as a high call-to-noise ratio, interference prevention and denial, and high network efficiency. The hologram and beamforming (HBF) is a new beamforming method which is significantly different from the MIMO system because a software-defined antenna is used. The HBF may be a very effective approach scheme for efficient and flexible transmission and reception of signals in a multi-antenna communication device.

### Big Data Analysis

The big data analysis is a complicated process for analyzing various large-scale data sets or big data. This process guarantees perfect data management by finding hidden data, and information such as a correlation and a customer tendency which may not be known. The big data is collected from various sources such as videos, social networks, images, and sensors. This technology is widely used to process vast data in the 6G system.

### Large Intelligent Surface (LIS)

A THz band signal has a strong straightness, so there may be a lot of shade regions due to obstacles, and an LIS technology becomes important in which the LIS is installed near such a shade region to expand a communication zone and to enable communication stability strengthening and additional services. The LIS is an artificial surface made of electromagnetic materials, and may change propagations of incoming radio waves and outgoing radio waves. The LIS may be shown as an extension of massive MIMO, but is different from the massive MIMO in terms of an array structure and an operating mechanism. Further, the LIS has an advantage of maintaining low power consumption in that the LIS operates as a reconfigurable reflector having passive elements, i.e., reflects signals only passively without using an active RF chain. Further, the reflector may be advantageous for the wireless communication channel because each passive reflector of the LIS should independently control a phase shift of an incident signal. By appropriately controlling the phase shift through an LIS controller, a reflected signal may be gathered in a target receiver to boost a received signal power.

The 6G communication technology described above may be applied in combination with methods proposed in the disclosure to be described below or may be supplemented to specify or clarify technical features of the methods proposed in the disclosure. In some embodiments, the communication service proposed in the disclosure may be applied in combination with communication services by 3G, 4G, and/or 5G communication technology, along with the 6G communication technology described above.

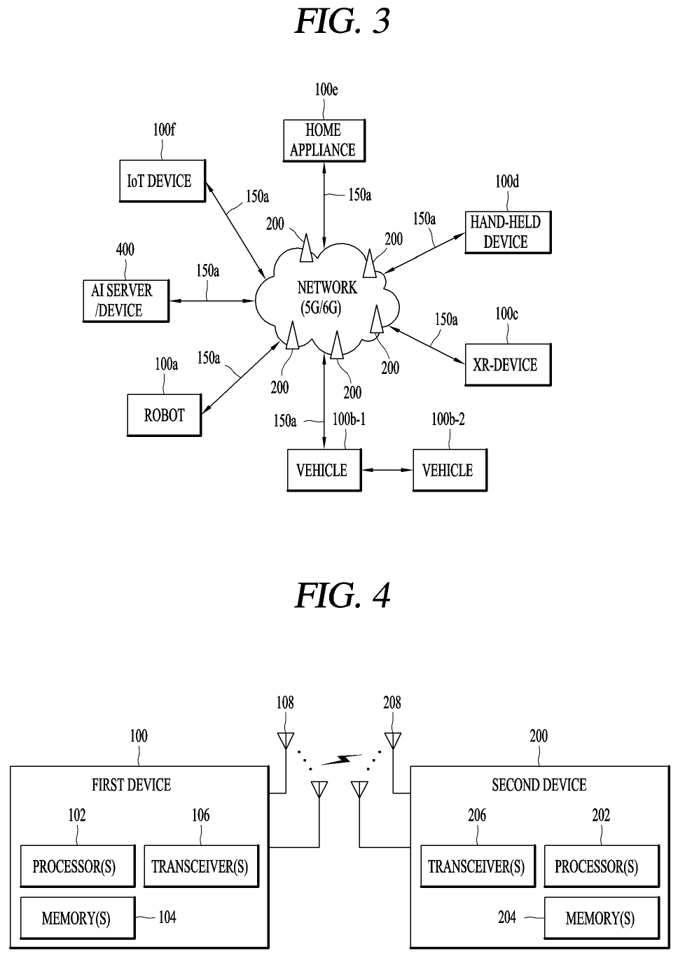

FIG. 3 is a view of examples of a communication system applied to the disclosure and devices performing wireless communication through the communication system. Referring to FIG. 3, a communication system 1 applied to the disclosure includes wireless devices, base stations, and a network. Herein, the wireless devices represent devices performing communications using radio access technology (RAT) (e.g., 5G new RAT (NR)) or long-term evolution (LTE)) and may be referred to as communication/radio/5G devices. The wireless devices may include, without being limited to, a robot 100a, vehicles 100b-1 and 100b-2, an eXtended reality (XR) device 100c, a hand-held device 100d, a home appliance 100e, an Internet of thing (IoT) device 100f, and an artificial intelligence (AI) device/server 400. For example, the vehicles may include a vehicle having a wireless communication function, an autonomous driving vehicle, and a vehicle capable of performing vehicle-to-vehicle communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, and the like. The hand-held device may include a smartphone, a smart pad, a wearable device (e.g., a smartwatch or smart glasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communications/connections 150a and 150b may be performed between the wireless devices 100a to 100f/BSs 200 and the BSs 200/wireless devices 100a to 100f. Here, wireless communications/connections may be performed through various radio access technologies (e.g., 5G NR) for uplink/downlink communication 150a and sidelink communication 150b (or D2D communication). Through the wireless communications/connections 150a and 150b, the wireless devices and the BSs/wireless devices may transmit/receive radio signals to each other. For example, the wireless communications/connections 150a and 150b may transmit/receive signals through various physical channels based on all/partial processes of FIG. A1. To this end, based on various proposals of the disclosure, at least some of various configuration information setting processes for transmitting/receiving radio signals, various signal processing processes (e.g., channel encoding/decoding, modulation/demodulation, resource mapping/demapping, and the like), or a resource allocation process may be performed.

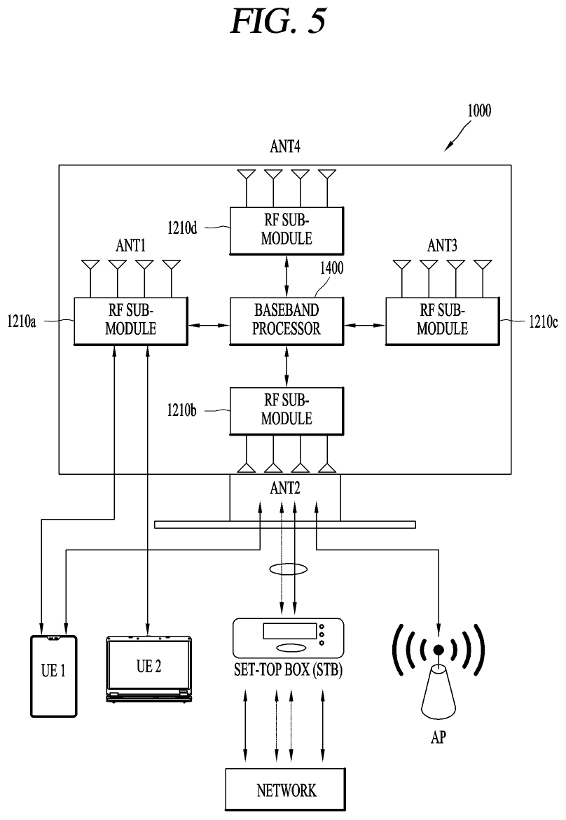

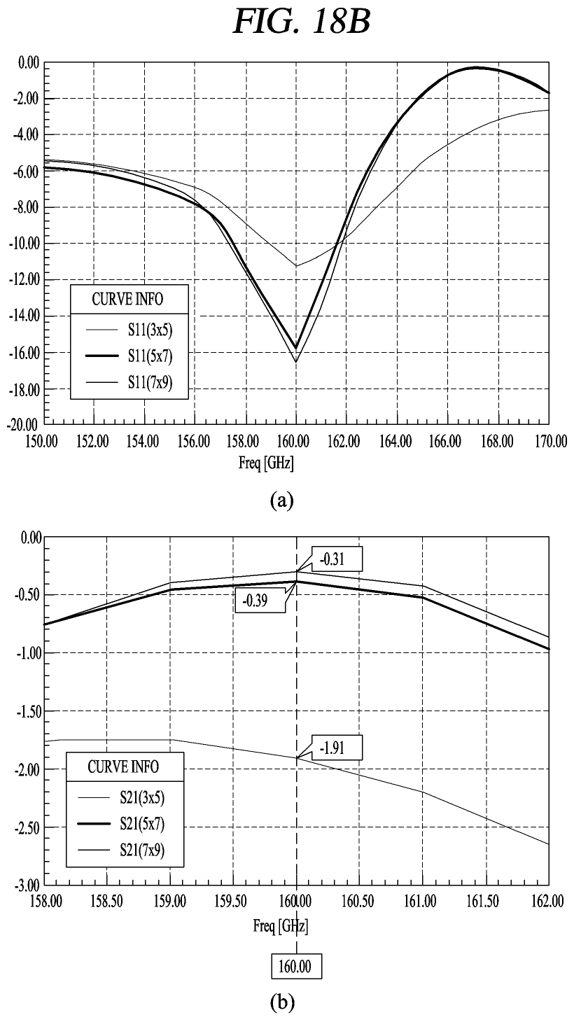

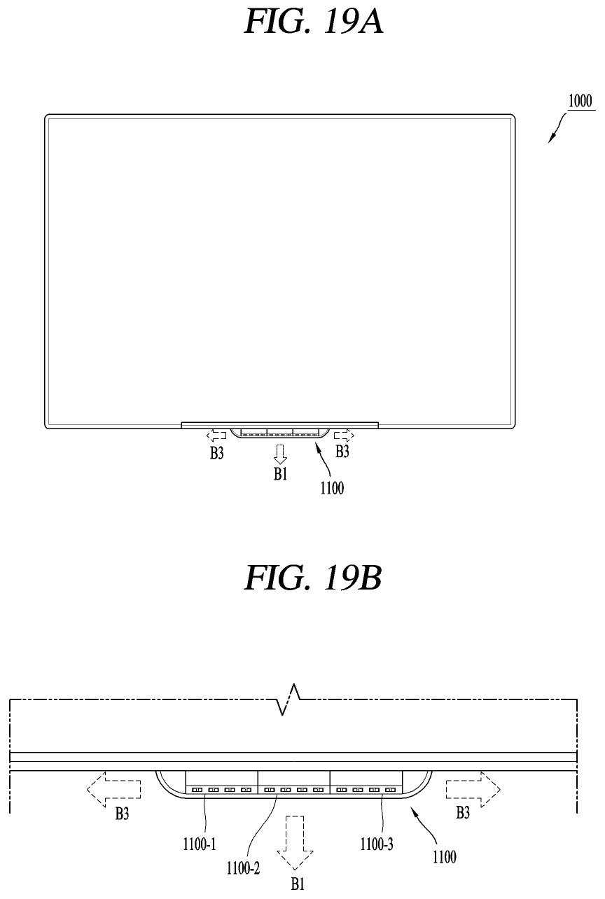

FIG. 4 is a view of a configuration of wireless devices performing wireless communications according to the specification. Referring to FIG. 4, a first wireless device 100 and a second wireless device 200 may transmit and receive radio signals through a variety of radio access technologies (e.g., LTE and NR). Herein, {the first wireless device 100 and the second wireless device 200} may correspond to {the wireless device 100x and the BS 200} and/or {the wireless device 100x and the wireless device 100x} of FIG. 19.

The first wireless device 100 may include at least one processor 102 and at least one memory 104 and may further include at least one transceiver 106 and/or at least one antenna 108. The processor 102 may control the memory 104 and/or the transceiver 106 and may be configured to implement the above described/proposed functions, procedures, and/or methods. For example, the processor 102 may process information inside the memory 104 to generate first information/signals and then transmit radio signals including the first information/signals through the transceiver 106. The processor 102 may receive radio signals including second information/signals through the transceiver 106 and then store information obtained by processing the second information/signals in the memory 104. The memory 104 may be connected to the processor 102 and may store a variety of information related to the operation of the processor 102. For example, the memory 104 may store software code including commands for performing some or all of processes controlled by the processor 102 or for performing the above described procedures and/or methods. Herein, the processor 102 and the memory 104 may be a part of a communication modem/circuit/chip designed to implement wireless communication technology (e.g., LTE and NR). The transceiver 106 may be connected to the processor 102 and transmit and/or receive radio signals through at least one antenna 108. The transceiver 106 may include a transmitter and/or a receiver. The transceiver 106 may be interchangeably used with a radio frequency (RF) unit. In the disclosure, the wireless device may also refer to a communication modem/circuit/chip.

The second wireless device 200 may include at least one processor 202 and at least one memory 204 and may further include at least one transceiver 206 and/or at least one antenna 208. The processor 202 may control the memory 204 and/or the transceiver 206 and may be configured to implement the above described/proposed functions, procedures, and/or methods. For example, the processor 202 may process information inside the memory 204 to generate third information/signals and then transmit radio signals including the third information/signals through the transceiver 206. The processor 202 may receive radio signals including fourth information/signals through the transceiver 206 and then store information obtained by processing the fourth information/signals in the memory 204. The memory 204 may be connected to the processor 202 and may store a variety of information related to the operation of the processor 202. For example, the memory 204 may store software code including commands for performing some or all of processes controlled by the processor 202 or for performing the above described procedures and/or methods. Herein, the processor 202 and the memory 204 may be a part of a communication modem/circuit/chip designed to implement radio access technologies (e.g., LTE and NR). The transceiver 206 may be connected to the processor 202 and transmit and/or receive radio signals through at least one antenna 208. The transceiver 206 may include a transmitter and/or a receiver. The transceiver 206 may be interchangeably used with an RF unit. In the disclosure, the wireless device may also refer to a communication modem/circuit/chip.

Hereinafter, hardware elements of the wireless devices 100 and 200 will be described in more detail. At least one protocol layer may be implemented by, without being limited to, at least one processor 102 and 202. For example, the at least one processor 102 and 202 may implement at least one layer (e.g., a functional layer, such as PHY, MAC, RLC, PDCP, RRC, or SDAP). The at least one processor 102 and 202 may generate at least one protocol data unit (PDU) and/or at least one service data unit (SDU) according to the functions, procedures, proposals, and/or methods disclosed in this document. The at least one processor 102 and 202 may generate messages, control information, data, or information according to the functions, procedures, proposals, and/or methods disclosed in this document. The at least one processor 102 and 202 may generate signals (e.g., baseband signals) including PDUs, SDUs, messages, control information, data, or information according to the functions, procedures, proposals, and/or methods disclosed in this document and provide the generated signals to the at least one transceiver 106 and 206. The at least one processor 102 and 202 may receive the signals (e.g., baseband signals) from the at least one transceiver 106 and 206, and acquire the PDUs, SDUs, messages, control information, data, or information according to the functions, procedures, proposals, and/or methods disclosed in this document.

The at least one processor 102 and 202 may be referred to as a controller, microcontroller, microprocessor, or microcomputer. The at least one processor 102 and 202 may be implemented by hardware, firmware, software, or a combination thereof. As an example, at least one application specific integrated circuit (ASIC), at least one digital signal processor (DSP), at least one digital signal processing device (DSPD), at least one programmable logic device (PLD), or at least one field programmable gate array (FPGA) may be included in the at least one processor 102 and 202. The functions, procedures, proposals, and/or methods disclosed in this document may be implemented using firmware or software and the firmware or software may be configured to include modules, procedures, or functions. Firmware or software configured to perform the functions, procedures, proposals, and/or methods disclosed in this document may be included in the at least one processor 102 and 202 or stored in the at least one memory 104 and 204 so as to be driven by the at least one processor 102 and 202. The functions, procedures, proposals, and/or methods disclosed in this document may be implemented using firmware or software in the form of code, commands, and/or a set of commands.

The at least one memory 104 and 204 may be connected to the at least one processor 102 and 202 and store various types of data, signals, messages, information, programs, code, instructions, and/or commands. The at least one memory 104 and 204 may be configured by a read-only memory (ROM), random access memory (RAM), electrically erasable programmable read-only memory (EPROM), flash memory, hard drive, register, cash memory, computer-readable storage medium, and/or a combination thereof. The at least one memory 104 and 204 may be located at the interior and/or exterior of the at least one processor 102 and 202. The at least one memory 104 and 204 may be connected to the at least one processor 102 and 202 through various technologies such as wired or wireless connection.

The at least one transceiver 106 and 206 may transmit user data, control information, and/or radio signals/channels, mentioned in the methods and/or operational flowcharts of this document, to at least one other device. The at least one transceiver 106 and 206 may receive user data, control information, and/or radio signals/channels, mentioned in the functions, procedures, proposals, methods, and/or operational flowcharts disclosed in this document, from at least one other device. For example, the at least one transceiver 106 and 206 may be connected to the at least one processor 102 and 202 and transmit and receive radio signals. For example, the at least one processor 102 and 202 may control the at least one transceiver 106 and 206 to transmit user data, control information, or radio signals to at least one other device. The at least one processor 102 and 202 may control the at least one transceiver 106 and 206 to receive user data, control information, or radio signals from at least one other device. The at least one transceiver 106 and 206 may be connected to the at least one antenna 108 and 208 and the at least one transceiver 106 and 206 may be configured to transmit and receive user data, control information, and/or radio signals/channels, mentioned in the functions, procedures, proposals, methods, and/or operational flowcharts disclosed in this document, through the at least one antenna 108 and 208. In this document, the at least one antenna may be a plurality of physical antennas or a plurality of logical antennas (e.g., antenna ports). The at least one transceiver 106 and 206 may convert received radio signals/channels from RF band signals into baseband signals to process received user data, control information, and/or radio signals/channels using the at least one processor 102 and 202. The at least one transceiver 106 and 206 may convert the user data, control information, and/or radio signals/channels processed using the at least one processor 102 and 202 from the base band signals into the RF band signals. To this end, the at least one transceiver 106 and 206 may include (analog) oscillators and/or filters.

In this regard, 6G wireless communication services are not only applicable to electronic devices, such as mobile terminals or image display devices. The 6G wireless communication services may be applied to electronic devices that support fully autonomous driving vehicles, artificial intelligence (AI) robots, and augmented/virtual reality (AR/VR)-based metaverses.

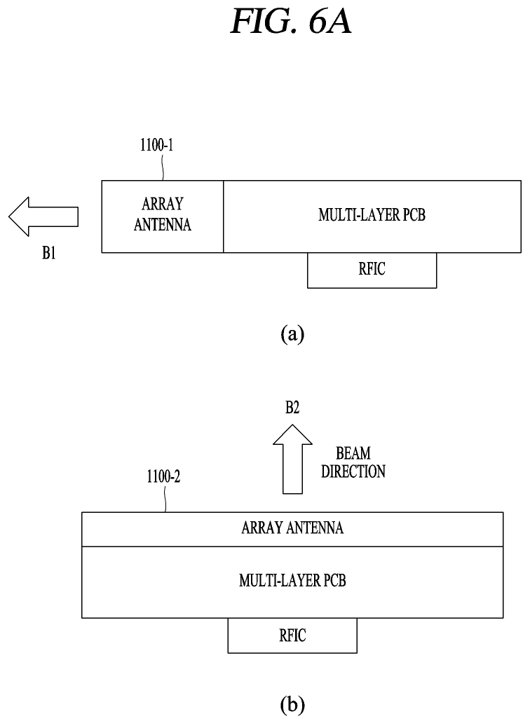

Hereinafter, an electronic device having an array antenna that may operate in an mmWave band or a terahertz band will be described. In this regard, FIG. 5 is a view of an electronic device including a plurality of antenna modules and a plurality of transceiver circuit modules according to an embodiment. Referring to FIG. 5, an electronic device in which a plurality of antenna modules and a plurality of transceiver circuit modules are arranged may be an image display device, but is not limited thereto. Therefore, the electronic device having the plurality of antenna modules and the plurality of transceiver circuit modules disclosed herein may include an arbitrary electronic device or vehicle that supports a communication service in a millimeter wave band or a terahertz band.

Referring to FIG. 5, the electronic device 1000 may include a plurality of antenna modules ANT1 to ANT4 and a plurality of transceiver circuit modules 1210a to 1210d. In this regard, the plurality of transceiver circuit modules 1210a to 1210d may correspond to the aforementioned transceiver circuit 1250. Or, the plurality of transceiver circuit modules 1210a to 1210d may be a partial configuration of the transceiver circuit 1250 or a partial configuration of a front end module disposed between the antenna module and the transceiver circuit 1250.

The plurality of antenna modules ANT1 to ANT4 may be configured as array antennas with a plurality of antenna elements. The number of elements of each antenna module ANT1 to ANT4 may be two, three, four, and the like as aforementioned, but it not limited thereto. For example, the number of elements of each of the antenna modules ANT1 to ANT4 may be expanded to two, four, eight, sixteen, and the like. Also, the elements of the antenna modules ANT1 to ANT4 may be selected by the same number or different numbers. The plurality of antenna modules ANT1 to ANT4 may be arranged in different areas of a display or on a lower or side surface of the electronic device. The plurality of antenna modules ANT1 to ANT4 may be arranged on upper, left, lower, and right sides of the display, but are not limited to this arrangement structure. As another example, the plurality of antenna modules ANT1 to ANT4 may be arranged on an upper left portion, an upper right portion, a lower left portion, and a lower right portion of the display.

The antenna modules ANT1 to ANT4 may be configured to transmit and receive signals at an arbitrary frequency band in a specific direction. For example, the antenna modules ANT1 to ANT4 may operate at any one of 28 GHz band, 39 GHz band, 64 GHz band, or 100 GHz band.

The electronic device may maintain a connection state with different entities through two or more of the antenna modules ANT1 to ANT4 or perform data transmission or reception for maintaining the connection state. In this regard, the electronic device corresponding to the display device may transmit or receive data to or from a first entity through the first antenna module ANT1. The electronic device may transmit or receive data to or from a second entity through the second antenna module ANT2. As one example, the electronic device may transmit or receive data to or from a mobile terminal (user equipment (UE)) through the first antenna module ANT1. The electronic device may transmit or receive data to or from a control device, such as a set-top box or access point (AP), through the second antenna module ANT2.

The electronic device may transmit or receive data to or from other entities through other antenna modules, for example, the third antenna module ANT3 and the fourth antenna module ANT4. As another example, the electronic device may perform dual connectivity or MIMO with at least one of the previously-connected first and second entities through the third antenna module ANT3 and the fourth antenna module ANT4.

Mobile terminals UE1 and UE2 may be arranged in a front region of the electronic device to communicate with the first antenna module ANT1. In other embodiments, the set-top box (STB) or the AP may be arranged in a lower region of the electronic device to communicate with the second antenna module ANT2 but is not limited thereto. As another example, the second antenna module ANT2 may include a first antenna radiating a signal to the lower region, and a second antenna radiating a signal to the front region. Therefore, the second antenna module ANT2 may perform communication with the set-top box (STB) or the AP through the first antenna, and perform communication with one of the mobile terminals UE1 and UE2 through the second antenna.

In some embodiments, one of the mobile terminals UE1 and UE2 may be configured to perform MIMO with the electronic device. As one example, the UE1 may be configured to perform MIMO while performing beamforming with the electronic device. As aforementioned, the electronic device corresponding to the image display device may perform high-speed communication with another electronic device or a set-top box through a WiFi radio interface. As one example, the electronic device may perform high-speed communication with another electronic device or a set-top box at a frequency band of at least 100 GHz through a 6G radio interface.

In the meantime, the transceiver circuit modules 1210a to 1210d may operate to process transmission signals and reception signals at an RF frequency band. Here, the RF frequency band, as aforementioned, may be an arbitrary frequency band of 28 GHz band, 39 GHz band, 64 GHz, or at least 100 GHz band. In some embodiments, the transceiver circuit modules 1210a to 1210d may be referred to as RF sub-modules 1210a to 1210d. At this time, the number of RF sub-modules 1210a to 1210d may not be limited to four, but may vary to an arbitrary number more than two depending on an application. A baseband processor 1400 may be configured to control the transceiver circuit modules 1210a to 1210d.

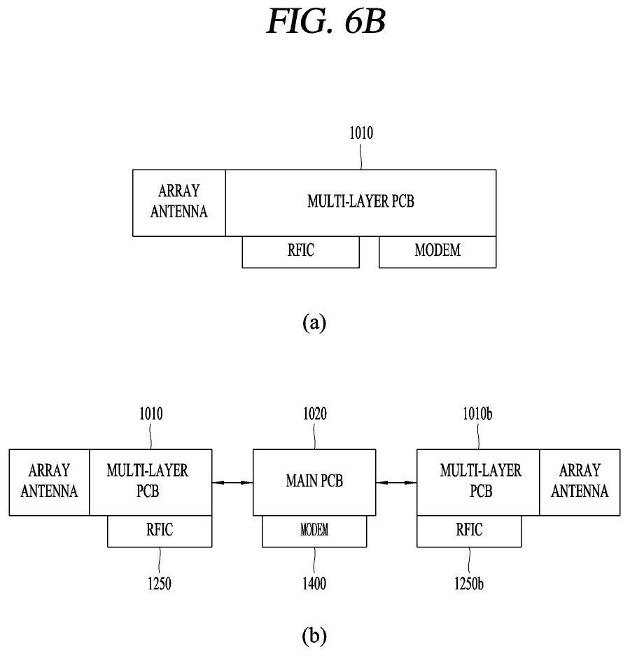

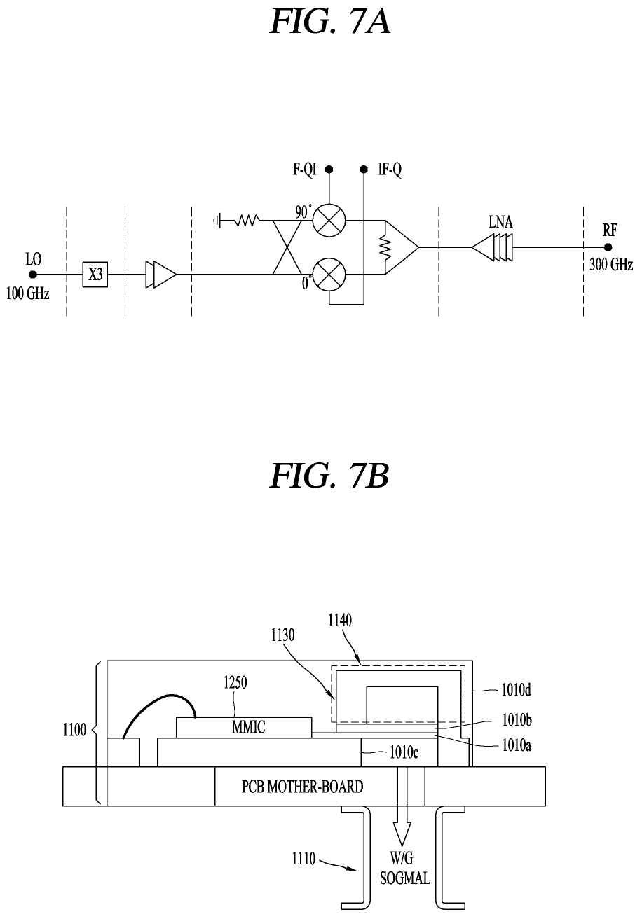

FIG. 6A is a view of a configuration, in which a multi-layer circuit board having an array antenna module is connected to an RFIC, in relation to THz band communication. Referring to (a) of FIG. 5A, the antenna module may be arranged for mmWave or THz band communication, and may be configured in an integral form of RFIC-PCB-antenna. In this regard, an array antenna module 1100-1, as illustrated in (a) of FIG. 6A, may be formed integrally with a multi-layer PCB. The array antenna module 1100-1 may be arranged in one side region of the multi-layer PCB. Accordingly, a first beam B1 may be formed toward the side region of the multi-layer PCB by using the array antenna module 1100-1 arranged in the one side region of the multi-layer PCB. Referring to (b) of FIG. 5A, an array antenna module 1100-2 may be arranged on top of the multi-layer PCB. A second beam B2 may be formed toward a front region of the multi-layer PCB by using the array antenna module 1100-2.

The first array antenna 1100-1 of (a) of FIG. 6A may be arranged in the side region of the multi-layer PCB and the second array antenna 1100-2 of (b) of FIG. 6A may be arranged in the side region of the multi-layer PCB. Accordingly, the first beam B1 may be generated through the first array antenna 1100-1 and the second beam B2 may be generated through the second array antenna 1100-2.

The first array antenna 1100-1 and the second array antenna 1100-2 may be configured to be in the same polarization. Or, the first array antenna 1100-1 and the second array antenna 1100-2 may be configured to be in orthogonal polarizations to each other. In this regard, the first array antenna 1100-1 may operate as a vertically polarized antenna and the second array antenna 1100-2 may operate as a horizontally polarized antenna.

In some embodiments, a multi-layer PCB in which an array antenna is arranged may be integrally formed with a main substrate or may be modularly coupled to the main substrate by a connector. In this regard, FIG. 6B is a view of coupling structures between a multi-layer substrate (PCB) and a main substrate according to embodiments. Referring to (a) of FIG. 6B, a structure in which an RFIC 1250 and a modem 1400 are integrally formed on a multi-layer PCB 1010 is illustrated. The modem 1400 may be referred to as a baseband processor 1400. Therefore, the multi-layer PCB 1010 may be integrally formed with the main substrate. The integral structure may be applied to a structure in which only one array antenna module is arranged in an electronic device.

In some examples, the multi-layer PCB 1010 and the main substrate 1020 may be modularly coupled to each other by a connector. Referring to (b) of FIG. 5B, the multi-layer PCB 1010 may be interfaced with the main substrate 1020 through the connector. In this instance, the RFIC 1250 may be arranged on the multi-layer PCB 1010 and the modem 1400 may be arranged on the main substrate 1020. Accordingly, the multi-layer PCB 1010 may be produced as a separate substrate from the main substrate 1020 and coupled to the main substrate 1020 through the connector.

The modular structure may be applied to a structure in which a plurality of array antenna modules are arranged in an electronic device. Referring to (b) of FIG. 6B, the multi-layer PCB 1010 and a second multi-layer PCB 1010b may be interfaced with the main substrate 1020 through connectors. The modem 1400 arranged on the main substrate 1020 may be electrically coupled to RFICs 1250 and 1250b, which are arranged on the multi-layer PCB 1010 and the second multi-layer PCB 1010b.

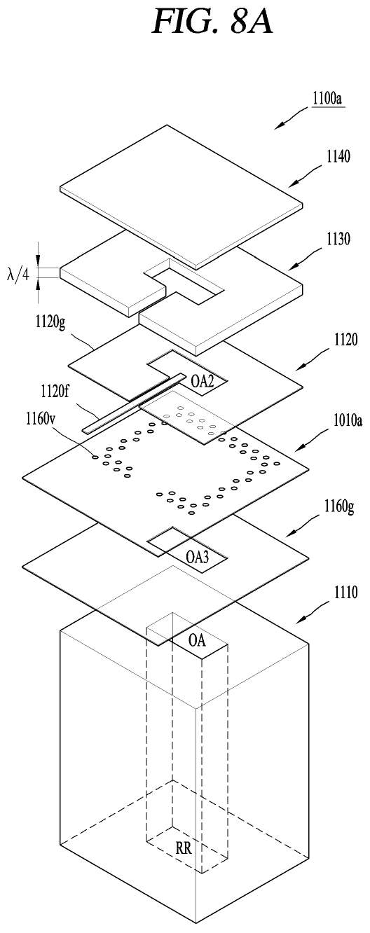

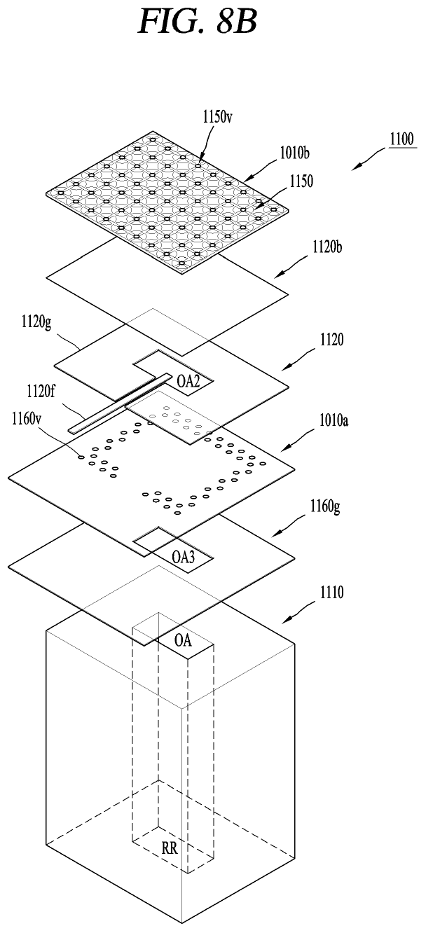

Hereinafter, an electronic device having antenna modules performing 6G wireless communication is described. In some embodiments, an antenna module having a microstrip-to-waveguide transition structure according to the specification is described. An antenna module having a microstrip-to-waveguide transition structure may be arranged in an electronic device performing terahertz-based communications. In this regard, FIG. 7A is a block diagram of a communication module that performs terahertz-based wireless communication of at least 100 GHz. FIG. 7B is a side view of a microstrip-to-waveguide transition structure in a communication module performing terahertz-based wireless communication of FIG. 7A.

Referring to FIG. 7A, a local oscillator LO may be configured to generate a signal of a frequency band of about 100 GHz. The signal output from the local oscillator LO may undergo a frequency conversion into a frequency, which is a specific multiple, for example, three times the frequency of the output signal. The frequency-converted signal may be amplified by a mid-power amplifier. Signals in an intermediate frequency (IF) band may include an in-phase signal IF-I and a quadrature phase signal IF-Q with a phase difference of 90 degrees. The signals in the intermediate frequency band may be combined with the frequency-converted signal and converted into RF signals. An RF signal of a communication module performing terahertz-based wireless communication may be a signal in a frequency band of about 300 GHz, but is not limited thereto. In the specification, an RF signal in a frequency band of about 160 GHz may be used.

Substrate loss may gradually increase as an operating frequency gets higher in THz-based communication, and thus waveguide-type antennas may be used in the design of an RF communication module that requires high output and low loss characteristics. Accordingly, the RF communication module may be referred to as an antenna module. Referring to FIG. 7B, the antenna module 1100 may be configured such that a transceiver circuit 1250 corresponding to an RF circuit and a dielectric substrate 1010a are electrically connected. The transceiver circuit 1250 may be implemented in the form of a monolithic microwave integrated chip (MMIC), but is not limited thereto. The transceiver circuit 1250 may be arranged on a PCB substrate 1010c, which is a distinct dielectric substrate from the dielectric substrate 1010a. Accordingly, it is necessary to design a signal transition structure to convert a signal of the transceiver circuit 1250 arranged on the PCB substrate 1010c and transmit the converted signal to a waveguide 1110. The antenna module 1100 including the transceiver circuit 1250 may be configured to be packaged in the form of a dielectric mold 1010d.

The specification proposes a microstrip-to-waveguide transition structure that is capable of improving signal conversion efficiency by using a metamaterial-based artificial magnetic conductor (AMC). The microstrip-to-waveguide transition structure according to the specification has the advantage in that a wide design space is not required unlike a cavity-type transition structure. In the cavity-type transition structure, a signal conversion portion 1130 is designed such that a termination portion of the waveguide 1110 extends by λ/4. This may result in increasing a height in a vertical direction.

Therefore, the microstrip-to-waveguide transition structure according to the specification may apply a metamaterial-based artificial magnetic conductor to the separate second dielectric substrate 1010b. Accordingly, there is no need to provide the signal conversion portion 1130 and the termination portion 1140 so that the termination portion 1140 of the waveguide 1110 extends by λ/4. Therefore, the microstrip-to-waveguide transition structure according to the specification may significantly reduce design space. This may facilitate the attachment of the metamaterial-based artificial magnetic conductor, and obtain better signal conversion efficiency than that of the structure including the signal conversion portion 1130 without an artificial magnetic conductor.

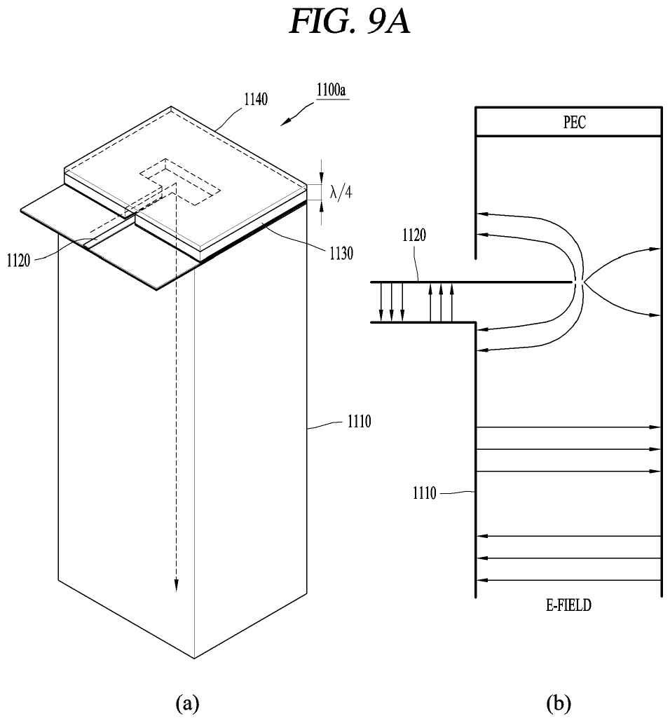

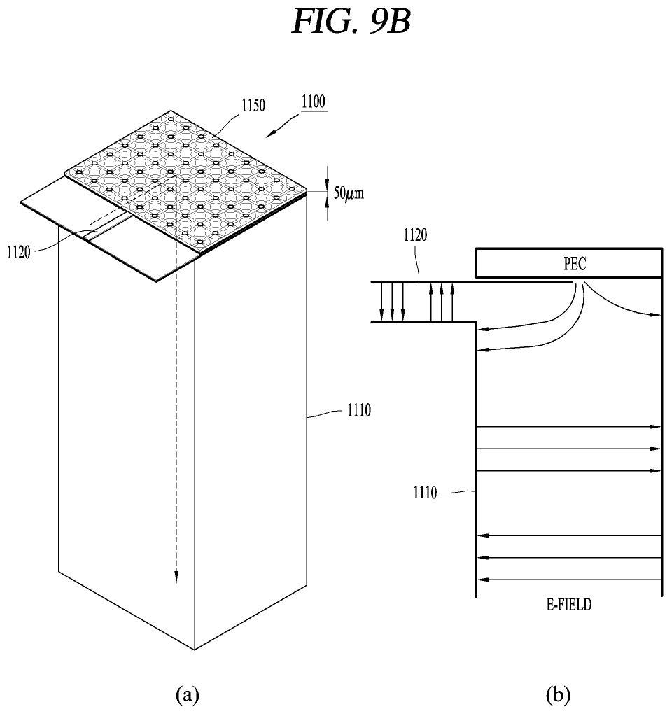

In some embodiments, FIGS. 8A and 8B are views of a stacked structure of an antenna module having a microstrip-to-waveguide transition structure. FIG. 8A illustrates a transition structure with the signal conversion portion 1130 applied in the vertical direction. FIG. 8B illustrates a transition structure with an artificial magnetic conductor (AMC) applied without a signal conversion portion. In this regard, FIGS. 9A and 9B are side perspective views of the microstrip-to-waveguide transition structures of FIGS. 8A and 8B, and internal electric field distributions in the microstrip-to-waveguide transition structures.

Referring to FIG. 8A, an antenna module 1100a may include a waveguide 1110, a transmission line 1120, a signal conversion portion 1130, and a termination portion 1140. The signal conversion portion 1130 and the termination portion 1140 may be formed of a metal material. The transmission line 1120 may be formed on the dielectric substrate 1010a in an upper region of the waveguide 1110. A ground pattern 1160g may be formed between the waveguide 1110 and the dielectric substrate 1010a. The transmission line 1120 and the ground pattern 1160g may be formed on front and rear surfaces of the dielectric substrate 1010a, respectively.

An RF signal transmitted along a signal pattern 1120f of the transmission line 1120 may be transmitted to an open area OA inside the waveguide 1110. For this purpose, the signal conversion portion 1130 may be formed in the vertical direction in the upper region of the transmission line 1120. The signal conversion portion 1130 may have a height of λ/4 in the vertical direction. The signal conversion portion 1130 may have an open area to correspond to an open area OA of the transmission line 1120. The open area OA2 may be formed in the transmission line 1120 to correspond to the open area OA of the waveguide 1110. An open area OA3 may be formed in the ground pattern 1160g to correspond to the open area OA of the waveguide 1110.

Referring to FIGS. 8A and 9A, in case of designing the microstrip-to-waveguide transition structure, the transmission line 1120 in the form of a microstrip line may be arranged at a distance of λ/4 from the termination portion 1140 of the waveguide 1110. Accordingly, the transition structure may be designed so that maximum current may be induced in the transmission line 1120. Therefore, an RF signal transmitted through the transmission line 1120 in the form of the microstrip line may be transmitted through the interior of the waveguide 1110. In this regard, an electric field formed through the transmission line 1120 may be formed vertically, and an electric field inside the waveguide 1110 may be formed horizontally. The vertical electric field in the transmission line 1120 may be decomposed into vertical and horizontal components through the signal conversion portion 1130. Therefore, the electric field may be formed in the horizontal direction in the waveguide 1110 coupled with the signal conversion portion 1130.

The height of the signal conversion portion 1130 may be designed to be λ/4, so that a signal transmitted through the waveguide 1110 and a signal reflected from the termination portion 1140 have in-phase characteristics in the transmission line 1120. This may further require a design space for extending the waveguide 1110 to a certain height. Further, processes such as cutting and milling may be required to form the signal conversion portion 1130 by extending the waveguide 1110, thereby making a manufacturing process complicated.

Hereinafter, an antenna module having a microstrip-to-waveguide transition structure with an artificial magnetic conductor (AMC) applied according to the specification will be described, with reference to FIGS. 7B, 8B, and 9B. An antenna module 1100 may include a waveguide 1110 and a transceiver circuit 1250. The antenna module 1100 may be configured to radiate a signal of a specific frequency band. The antenna module 1100 may be configured to radiate a signal of a frequency band of at least 28 GHz, i.e., a signal of the mmWave band. The antenna module 1100 may be configured to radiate a signal of a frequency band of at least 100 GHz or at least 140 GHz, i.e., a signal of a 6G frequency band.

The transceiver circuit 1250 may be operably coupled to the antenna module 1100. The transceiver circuit 1250 may be configured to transmit a signal of a specific frequency band to the antenna module 1100. The antenna module 1100 may include a waveguide 1110, a transmission line 1120, and a conductive surface 1150. The antenna module 1100 may further include a first dielectric substrate 1010a and a second dielectric substrate 1010b.

The waveguide 1110 may be configured to have an open area OA at one end in the lengthwise direction of the waveguide 1110 so that a signal of a specific frequency band is transmitted. The waveguide 1110 may have a radiation region RR formed at another end in the lengthwise direction so that the signal of the specific frequency band is radiated. The radiation region RR may have an area which is equal to an area of the open area OA or larger than the area of the open area OA to have an antenna gain of at least a certain value.

The transmission line 1120 may be formed on one surface of the first dielectric substrate 1010a. The transmission line 1120 may include a signal pattern 1120f, a first ground pattern 1120g, and a second open area OA2. A second ground pattern 1150g may be formed on one surface of the second dielectric substrate 1010b arranged in the upper region of the first dielectric substrate 1010a. A third ground pattern 1160g may be formed on another surface of the first dielectric substrate 1010a. The first dielectric substrate 1010a and the second dielectric substrate 1010b may be attached by an adhesive sheet 1120b. The thickness of the adhesive sheet 1120b may be formed to be thinner than or equal to a certain thickness, for example, 5 um, but is not limited thereto.

The first ground pattern 1120g and the third ground pattern 1160g formed on the one surface and the another surface of the first dielectric substrate 1010a may be connected to a plurality of vias. The plurality of vias may be arranged at a certain distance from a boundary of the signal pattern 1120f and a boundary of the second open area OA2 and may form a second via structure 1160v.

The conductive surface 1150 may include a plurality of conductive patterns 1150c arranged in one axial direction and another axial direction. The conductive surface 1150 including the plurality of conductive patterns arranged in the one axial direction and the another axial direction may be referred to as an artificial magnetic conductor (AMC).

The conductive surface 1150 may be implemented with an impedance of at least a threshold value in a specific frequency band. The conductive surface 1150 may be implemented with an impedance of at least a threshold value in a specific frequency band so that a signal of the specific frequency band is not radiated to the upper region of the conductive surface 1150. The conductive surface 1150 may be arranged in the upper region of the transmission line 1120, so that the signal of the specific frequency band transmitted through the transmission line 1120 is transmitted to the lower region other than the upper region. Accordingly, the signal of the specific frequency band transmitted through the transmission line 1120 may be transmitted to the interior of the waveguide 1110, which is the lower region of the transmission line 1120, and radiated through the radiation region RR.

In this regard, a vertical electric field may be formed through the transmission line 1120 which has the form of the microstrip line. The conductive surface 1150 having the form of the AMC may be configured as a perfect magnetic conductor (PMC). A phase of a signal reflected from the conductive surface 1150 may be formed to be the same as a phase of an incident signal. Accordingly, without a signal conversion portion having a certain height, the signal transmitted through the transmission line 1120 by the conductive surface 1150 having the form of the AMC may be transmitted to the interior of the waveguide 1110 without loss.

Therefore, the specification proposes an ultrathin microstrip-to-waveguide transition structure using a metamaterial such as the AMC. The conductive surface 1150 and the transmission line 1120 having the form of the microstrip line may theoretically transmit the maximum current into the waveguide 1110 at an interval of zero (0). In the specification, an adhesive surface 1120 of a certain thickness may be arranged to suppress a short-circuit due to a conductor of the conductive surface 1150 and a conductor of the waveguide 1110. The adhesive surface 1120 may be arranged between the transmission line 1120 on the first dielectric substrate 1010a and the conductive surface 1150 on the second dielectric substrate 1010b. The adhesive surface 1120 may be configured as an adhesive having a thickness in a certain range based on about 50 μm, but is not limited thereto. The adhesive surface 1120 may be inserted into a spacing between the open area OA of the waveguide 1110 and the transmission line 1120 and the conductive surface 1150.

Accordingly, the adhesive surface 1120 may attach the waveguide 1110 and the conductive surface 1150 while minimizing the design space of the microstrip-to-waveguide transition structure. In some embodiments, unlike a λ/4 cavity transition structure, the microstrip-to-waveguide transition structure may not cause additional path loss for the extended waveguide and loss due to signal reflection, thereby achieving higher signal transmission efficiency. For example, the cavity transition structure having the signal conversion portion has a signal loss value of about 0.63 B at 160 GHz. In some embodiments, the transition structure having the conductive surface 1150 may have a signal loss value of about 0.3 dB at 160 GHz, resulting in improvement of signal conversion efficiency of about 0.33 dB.

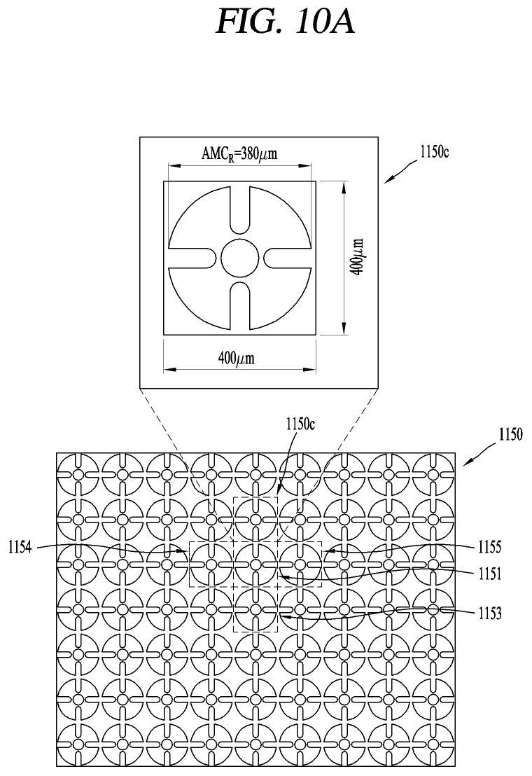

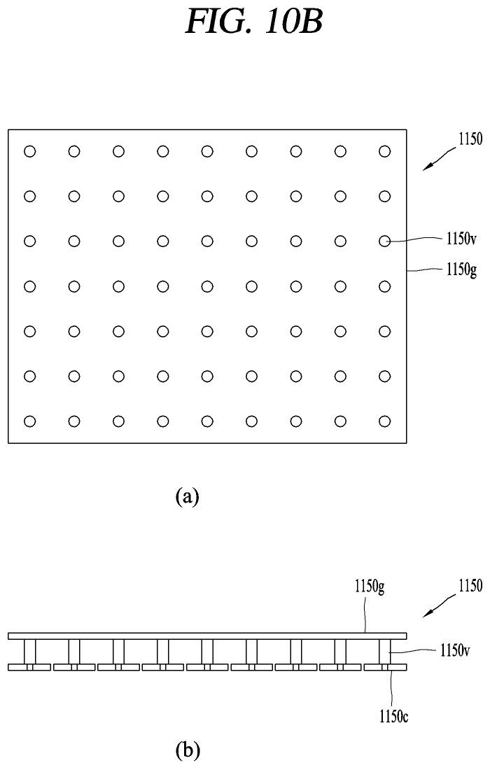

The first dielectric substrate 1010a on which the transmission line 1120 is formed may be arranged in the open area OA of the waveguide 1110. In this regard, FIG. 10 illustrates a structure in which the transmission line and the conductive surface implemented as the artificial magnetic conductor are overlaid. Referring to FIG. 10, the transmission line 1120 may be formed on one surface of the first dielectric substrate 1010a. The second dielectric substrate 1010b may be arranged in the upper region of the first transparent dielectric substrate 1010a. The second dielectric substrate 1010b may be arranged to be stacked on the first dielectric substrate 1010a. The second dielectric substrate 1010b may be arranged to overlap the first dielectric substrate 1010a in the vertical direction. The conductive surface 1150 having the form of the artificial magnetic conductor (AMC) that constitutes the microstrip-to-waveguide transition structure may be formed on the second dielectric substrate 1010b.

In some embodiments, the conductive surface 1150 having the form of the artificial magnetic conductor (AMC) constituting the microstrip-to-waveguide transition structure according to the specification may have a structure in which a plurality of unit cell structures are arranged in the horizontal and vertical directions. In this regard, FIG. 10A is a view of a structure in which the unit cell structures are arranged in the horizontal and vertical directions on the conductive surface having the form of the artificial magnetic conductor of FIG. 8B.

FIG. 10B is a view of a structure of another surface and side surface of the conductive surface having the form of the artificial magnetic conductor of FIG. 8B. In some embodiments, (a) of FIG. 10B illustrates a structure in which ground patterns are arranged on one surface, i.e., in an upper region, of the conductive surface 1150 of FIG. 8. (b) of FIG. 10B is a side view of a structure, in which the plurality of conductive patterns and ground patterns of the conductive surface 1150 of FIG. 8B are connected by vertical vias.

Referring to FIGS. 8B, 10A, and 10B, the second ground pattern 1150g may be formed on one surface of the second dielectric substrate 1010b. The conductive surface 1150 may have a plurality of conductive patterns 1150c arranged in one axial direction and another axial direction on another surface of the second dielectric substrate 1010b. Unit cell structures constituting the plurality of conductive patterns 1150c may be formed to have a certain length and width or less in an RF frequency band. For example, the unit cell structure may be formed at 160 GHz in a certain range based on 400 um×400 um. The length and width of the conductive pattern of the unit cell structure may be formed in a certain range based on 380 um×380 um.

The antenna module 1100 may further include via structures 1150v. The via structures 1150v may be configured to vertically connect the plurality of conductive patterns 1150c of the conductive surface 1150 and the second ground pattern 1150g. A first length in one axial direction of a region where the conductive surface 1150 is arranged may be at least twice a second length in the one axial direction of the open area OA. A first width in another axial direction of the region where the conductive surface 1150 is arranged may be at least twice a second width in the another axial direction of the open area OA. In this regard, the one axial direction of the region where the conductive surface 1150 is arranged may be an E-plane direction that matches an electric field direction inside the waveguide 1110. The another axial direction of the region where the conductive surface 1150 is arranged may be an H-plane direction perpendicular to the electric field direction inside the waveguide 1110.

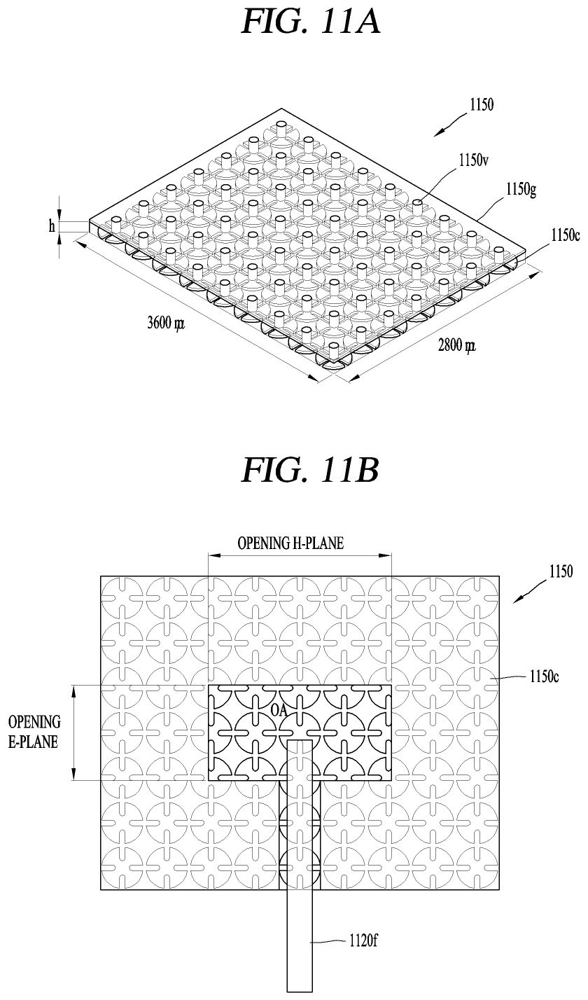

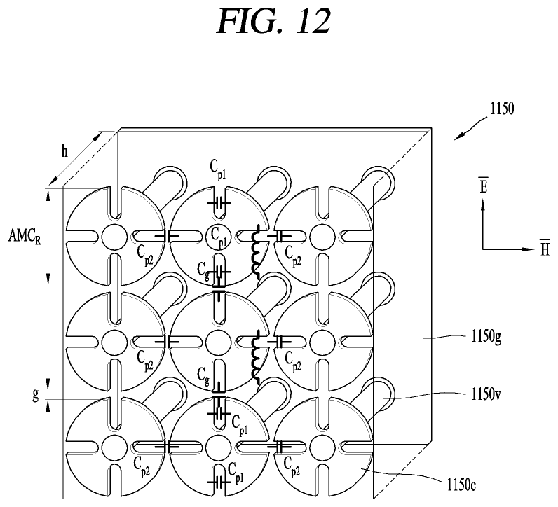

Referring to FIGS. 7B, 8B, and 9B to 10B, the artificial magnetic conductor (AMC) including the plurality of conductive patterns 1150c may include a plurality of unit grids. The AMC may include a plurality of slot patterns. In this regard, FIG. 11A is a side perspective view of a plurality of unit cell structures, constituting a conductive surface, formed on a substrate. FIG. 11B is a view of a structure in which the plurality of unit cell structures of FIG. 11A are arranged in the open area of the waveguide.

Referring to FIGS. 10B and 11A, the second ground pattern 1150g may be formed on one surface of the second dielectric substrate 1010b. The plurality of conductive patterns 1150c having the AMC form may be formed on another surface of the second dielectric substrate 1010b. The second dielectric substrate 1010b may have certain length, width, and thickness h.

Referring to FIGS. 10A to 11B, a first length in one axial direction of a region where the conductive surface 1150 is arranged may be at least twice a second length in the one axial direction of the open area OA. A first width in another axial direction of the region where the conductive surface 1150 is arranged may be at least twice a second width in the another axial direction of the open area OA. To this end, the conductive surface 1150 may include at least M unit cell structures of the conductive pattern in a horizontal direction, which is the one axial direction, and at least N unit cell structures of the conductive pattern in a vertical direction, which is the another axial direction. For example, the conductive surface 1150 may include nine unit cell structures and seven unit cell structures in the horizontal and vertical directions, respectively. The unit cell structure of the conductive pattern may have length and width of 400 um×400 um, and the conductive surface 1150 may have length and width of 3600 um×2800 um.

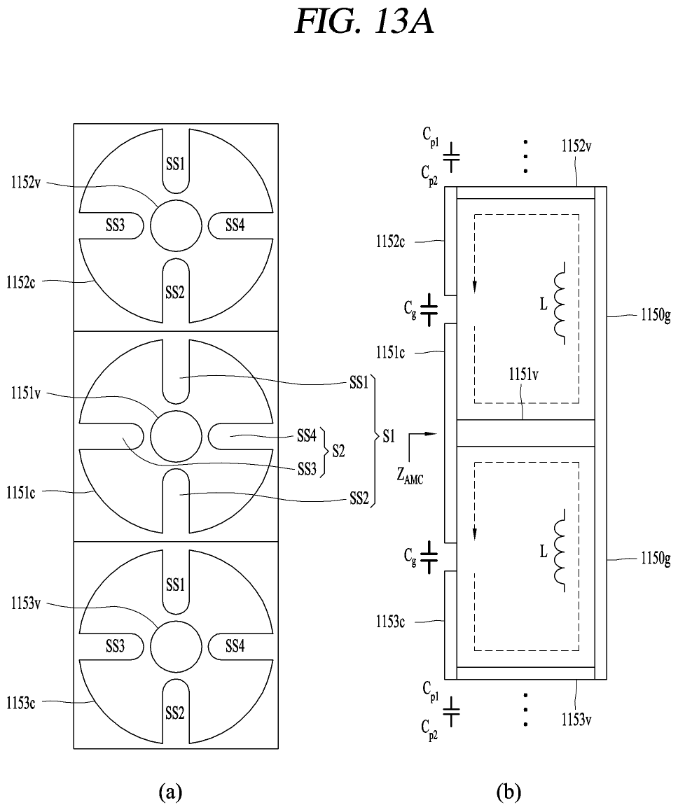

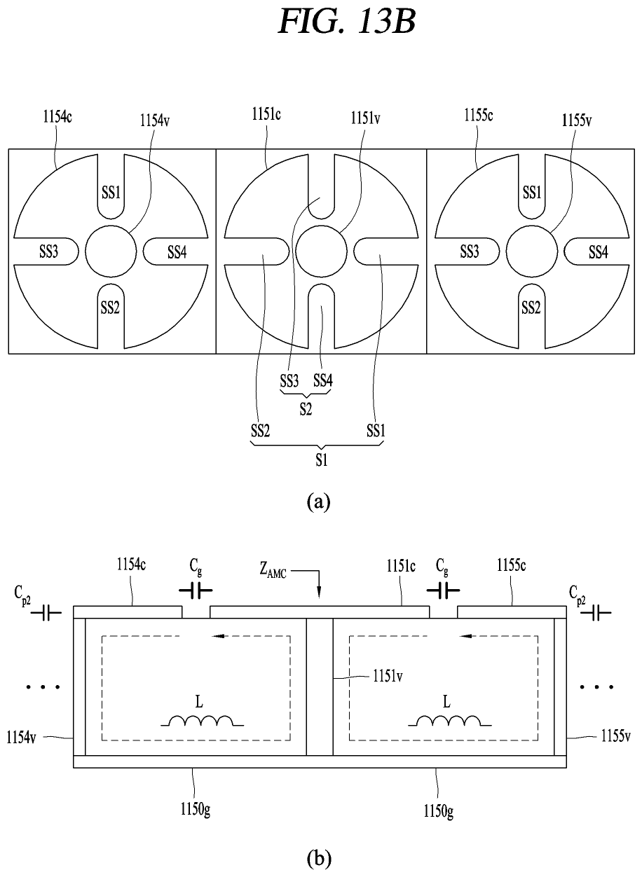

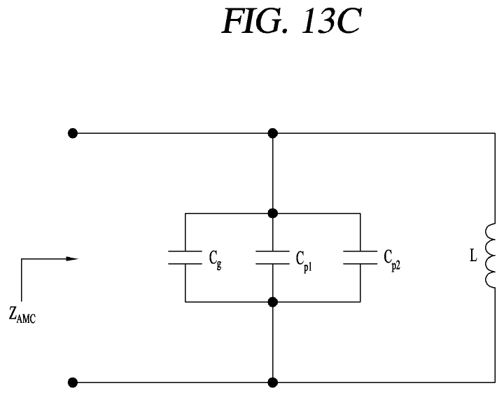

In some embodiments, a microstrip-to-waveguide transition structure according to the disclosure may be formed by capacitance and inductance values which are formed between adjacent unit cells of the conductive surface 1150 having the form of an artificial magnetic conductor (AMC). In this regard, FIG. 12 is a view of an equivalent circuit of the conductive surface on which the artificial magnetic conductor of FIG. 10A is formed. FIGS. 13A and 13B are views of a structure in which the unit cell structures of the artificial magnetic conductor of FIG. 10A are formed in the vertical and horizontal directions, and an equivalent circuit of the structure. FIG. 13C is a view of an equivalent circuit showing an input impedance based on the conductive surface of the artificial magnetic conductor of FIGS. 13A and 13B.

Referring to FIG. 13A, the conductive patterns 1151c, 1152c, and 1153c of the unit cell structures arranged vertically may be implemented as the AMC. Referring to FIG. 13B, the conductive patterns 1151c, 1154c, and 1153c of the unit cell structures arranged horizontally may be implemented as the AMC.

Referring to FIGS. 7B, 8B, and 9B to 13C, the conductive surface 1150 implemented as the AMC may include a first slot pattern S1 and a second slot pattern S2. The first slot pattern S1 may be formed in an electric field direction of a signal, which is one axial direction based on a center point where the vertical via is connected. The second slot pattern S2 may be formed in a magnetic field direction of a signal, which is another axial direction based on the center point where the vertical via is connected.

An inductance L may be induced to correspond to a current, which is formed in the second ground pattern 1150g between adjacent vertical vias of the via structure 1150v. A capacitance Cg may be induced between the second slot patterns S2 of adjacent conductive patterns in the electric field direction among the plurality of conductive patterns 1150c. A first capacitance Cp1 may be induced in the first slot pattern S1. A second capacitance Cp2 may be induced in the second slot pattern S2.

A unit cell of the plurality of conductive patterns 1150c constituting the conductive surface 1150 may include a conductive pattern 1151c, a first slot pattern S1, and a second slot pattern S2. The conductive pattern 1151c may be formed in a circular shape to correspond to the circular shape of the vertical via constituting the via structure 1150v. The first slot pattern S1 may be formed on the conductive pattern 1151c to be symmetrical to the vertical via in the one axial direction. The second slot pattern S2 may be formed on the conductive pattern 1151c to be symmetrical to the vertical via in the another axial direction.

The first slot pattern S1 may include a first sub-slot SS1 and a second sub-slot SS2 formed in upper and lower regions of the vertical via. The second slot pattern S2 may include a third sub-slot SS3 and a fourth sub-slot SS4 formed in left and right regions of the vertical via.

The first sub-slot SS1 to the fourth sub-slot SS4 may have a first length L1 to a fourth length L4 in the one axial direction, respectively. The first sub-slot SS1 to the fourth sub-slot SS4 may have a first width W1 to a fourth width W4 in the another axial direction, respectively. The first length L1 to the fourth length L4 in the one axial direction and the another axial direction may be set to be the same or to have a difference in a certain range. The first width W1 to the fourth width W4 in the one axial direction and the another axial direction may be set to be the same or to have a difference in a certain range.

The first length L1 to the fourth length L4 of the first sub-slot SS1 to the fourth sub-slot SS4 may be formed to be smaller than a difference in radius between the conductive pattern 1151c and the vertical via 1151v. The first length L1 to the fourth length L4 may be formed to be smaller than a difference between a first radius of the conductive pattern 1151c and a second radius of a connection region of the vertical via 1151v connected to the conductive pattern 1151c.

The shapes of end portions of the first sub-slot SS1 to the fourth sub-slot SS4 may also be formed to correspond to or be similar to the circular shape of the conductive pattern 1151c. End portions of the first sub-slot SS1 to the fourth sub-slot SS4 adjacent to the vertical via 1151v may be formed in a semicircular shape. A third radius of the end portions of the first sub-slot SS1 to the fourth sub-slot SS4 having the semicircular shape may be formed to be smaller than the second radius of the vertical via 1151v. The first width W1 to the fourth width W4 of the first sub-slot SS1 to the fourth sub-slot SS4 may also be formed to be smaller than the second radius of the vertical via 1151v.

Referring to FIG. 10, the number M of unit cells in the one axial direction may be greater than the number N of unit cells in the another axial direction. The conductive surface 1150 may have at least M unit cells arranged in the one axial direction. The conductive surface 1150 may have at least N unit cells arranged in the another axial direction. M may be greater than N because the length of the open area OA of the waveguide 1110 is greater than the width.

First and second current paths may be formed in relation to adjacent unit cells in opposite directions. A first unit cell 1151, a second unit cell 1152, and a third unit cell 1153, which are adjacent in the one axial direction, may have a first vertical via 1151v, a second vertical via 1152v, and a third vertical via 1153v, respectively. The first current path may be formed along the conductive pattern 1151c of the first unit cell 1151, the first vertical via 1151v, the second ground pattern 1150g, the second vertical via 1152v, and the conductive pattern 1152c of the second unit cell 1152. The second current path may be formed along the conductive pattern 1153c of the third unit cell 1153, the third vertical via 1153v, the second ground pattern 1150g, the first vertical via 1151v, and the conductive pattern 1151c of the first unit cell 1151. A first direction of the first current path and a second direction of the second current path may be formed in opposite directions.

Likewise, a first unit cell 1151, a fourth unit cell 1154, and a fifth unit cell 1155, which are adjacent in the another axial direction, may have a first vertical via 1151v, a fourth vertical via 1154v, and a fifth vertical via 1155v, respectively. A first direction of the first current path of the another axial direction and a third direction of a third current path may be formed in opposite directions.

The first unit cell 1151 and the second unit cell 1152 adjacent to each other in the one axial direction may be spaced apart from each other by at least a first gap. The first unit cell 1151 and the second unit cell 1154 adjacent to each other in the another axial direction may be spaced apart from each other by at least a second gap. Adjacent unit cells implemented as the AMCs may be formed to partially share a slot pattern or have the slot patterns interconnected. The first slot patterns S1 of the first unit cell 1151 and the second unit cell 1152 in the one axial direction may be interconnected. The second slot patterns S2 of the first unit cell 1151 and the fourth unit cell 1154 in the another axial direction may be interconnected.

The unit cell may have a size in the one axial direction and the another axial direction to be in a range of 10 um based on 380 um. The first unit cell 1151 and the second unit cell 1152 may be arranged spaced apart from each other in a range of 10 to 20 um in the one axial direction. The first unit cell 1151 and the second unit cell 1152 may be arranged spaced apart from each other in a range of 10 to 20 um in the another axial direction. A signal of a specific frequency band transmitted from the waveguide 1110 to a signal pattern of the transmission line 1120 may be a signal of a frequency band in a range of 158 GHz to 162 GHz, but is not limited thereto.

According to a transmission line analysis technique, an inductance L and a capacitance Cg of the conductive surface 1150 implemented as the AMC may be set as expressed in Mathematical Equation 1.

$$L = {μ}_{0} h , \qquad [ Mathematical Equation 1 ]$$

$${C}_{g} = ( A M {C}_{R {ε}_{0}} ( 1 + {ε}_{r} ) ) / {πcosh}^{− 1} ( ( A M {C}_{R} + g ) / g )$$

An impedance Z_{AMC} of the conductive surface 1150 implemented as the AMC from Mathematical Expression 1 may be set as expressed in Mathematical Expression 2. In some embodiments, a resonant frequency fr of the conductive surface 1150 implemented as the AMC may be set as expressed in Mathematical Expression 3.

$$[ Mathematical Equation 2 ]$$

$${Z}_{A M C} ( ω ) = {Z}_{C} ‖ {Z}_{L} = j ω L / ( 1 − {ω}^{2} L ( {C}_{g} + {C}_{p 1} + {C}_{p 2} ) )$$

$$[ Mathematical Equation 3 ]$$

$${f}_{r} = \frac{1}{2 π \sqrt{( L ( {C}_{g} + {C}_{p 1 +} {C}_{p 2} )}}$$

In this regard, AMC_{R} denotes a diameter of an AMC unit structure, h denotes a substrate thickness (AMC unit structure-ground plane distance), and g denotes a gap between adjacent AMC unit structures. L denotes an inductance corresponding to an adjacent AMC unit structure-ground plane current path in an E-field vector direction, and C_{g} denotes an electrostatic capacitance corresponding to a gap between the adjacent AMC unit structures in the E-field vector direction. Cₚ₁ denotes a parasitic capacitance due to unwanted polarization occurring between slots of the AMC unit structures, and Cₚ₂ denotes a parasitic capacitance due to unwanted polarization between adjacent AMC unit structures in an H-field vector direction. ε₀ denotes a free space permittivity, εᵣ denotes a substrate effective permittivity, μ₀ denotes a free space phase permeability, and fᵣ denotes a resonant frequency of the proposed AMC. Z_{C} denotes a capacitive impedance of the proposed AMC, Z_{L} denotes an inductive impedance of the proposed AMC, and Z_{AMC} denotes a characteristic impedance of the proposed AMC.

Referring to Mathematical Equation 2, the change in the AMC_{R} value may significantly affect the change in the Cg value. Therefore, as the AMC_{R} value increases, the Cg value may increase, which may shift the resonant frequency fr to a lower frequency. In determining the resonant frequency fr, Cₚ₁ and Cₚ₂ may have an inverse proportional relationship, but a great frequency shift effect may not be expected because the values are relatively small compared to Cg. Nonetheless, by further forming the slot shapes of the first and second slots 1151s and 1152s in the unit grid structure, a parasitic capacitance may be formed, thereby realizing a higher characteristic impedance in a specific frequency band than that in another frequency band.

In some embodiments, in the antenna module having the microstrip-to-waveguide transition structure according to the specification, the open areas may be implemented to oppose each other with the same shape. One surface of the first dielectric substrate 1010a may be located to oppose the second dielectric substrate 1010b on which the conductive surface 1150 is formed. Another surface of the first dielectric substrate 1010a may be arranged to oppose the open area OA of the waveguide 1110. A third ground pattern 1160g formed on the another surface of the first dielectric substrate 1010a may have a third open area OA3 formed to correspond to the open area OA of the waveguide 1110.

In the antenna module having the microstrip-to-waveguide transition structure according to the specification, open areas having the same shape and area may be implemented to oppose each other. In this regard, the open areas may be formed to have the same length and width.

A first length of the open area OA of the waveguide 1110 in the one axial direction and a second length of the second open area OA2 of the transmission line 1120 in the one axial direction may be formed to be the same. A third length of the third open area OA3 of the first dielectric substrate 1010a in the one axial direction may also be formed to be the same as the first length and the second length. A first width of the open area OA of the waveguide 1110 in the another axial direction and a second width of the second open area OA2 of the transmission line 1120 in the another axial direction may be formed to be the same. A third width of the third open area OA3 of the first dielectric substrate 1010a in the another axial direction may also be formed to be the same as the first width and the second width. The one axial direction and the another axial direction may be formed in an electric field direction and a magnetic field direction of a signal transmitted through the waveguide 1110.

In some embodiments, in the antenna module having the transition structure according to the specification, a signal transmitted through the transmission line 1120 may be transmitted from the transceiver circuit 1250 into the waveguide 1110 and radiated through the radiation region RR of the waveguide 1110. In this regard, a first ground pattern 1120g may be arranged at one side and another side of the signal pattern 1120f of the transmission line 1120 to be spaced apart from the signal pattern 1120f. The signal pattern 1120f may be referred to as a feeding pattern because the signal pattern 1120f feeds a signal to the waveguide 1110 of the antenna module 1100. The first ground pattern 1120g may be formed at both sides of the signal pattern 1120f on the same plane as the signal pattern 1120f, thereby forming a Co-planar waveguide (CPW) feeding structure.

One end of the signal pattern 1120f may be electrically connected to the transceiver circuit 1250 arranged on the third dielectric substrate 1010c of FIG. 7C, which is arranged separately from the first dielectric substrate 1010a. The first ground pattern 1120g may be formed to surround another end, one surface, and another surface of the signal pattern 1110f. The first ground pattern 1120g may be formed to surround the signal pattern 1110f to minimize signal loss in a high frequency band of at least 140 GHz. The another end of the signal pattern 1110f may be formed inside the second open area OA2 of the transmission line 1120. Accordingly, a signal transmitted through the transmission line 1120 may be transmitted from the transceiver circuit 1250 into the waveguide 1110 and radiated through the radiation region RR of the waveguide 1110.

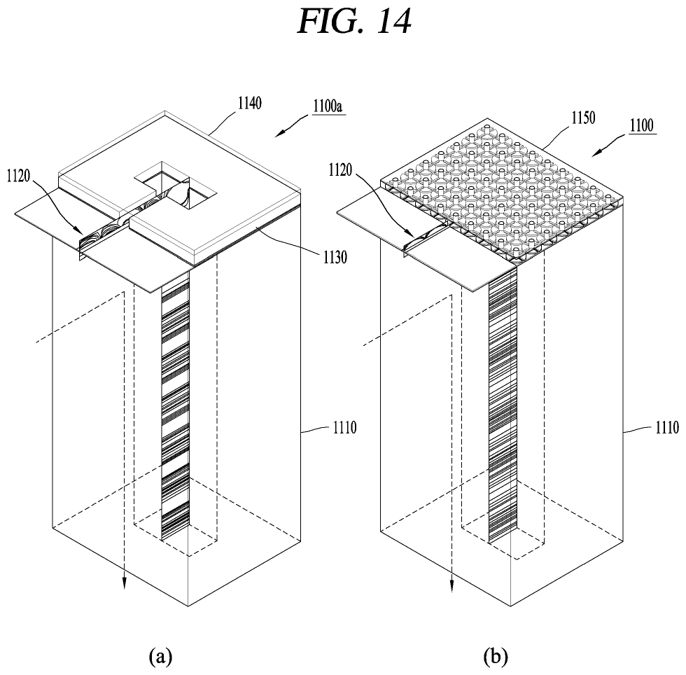

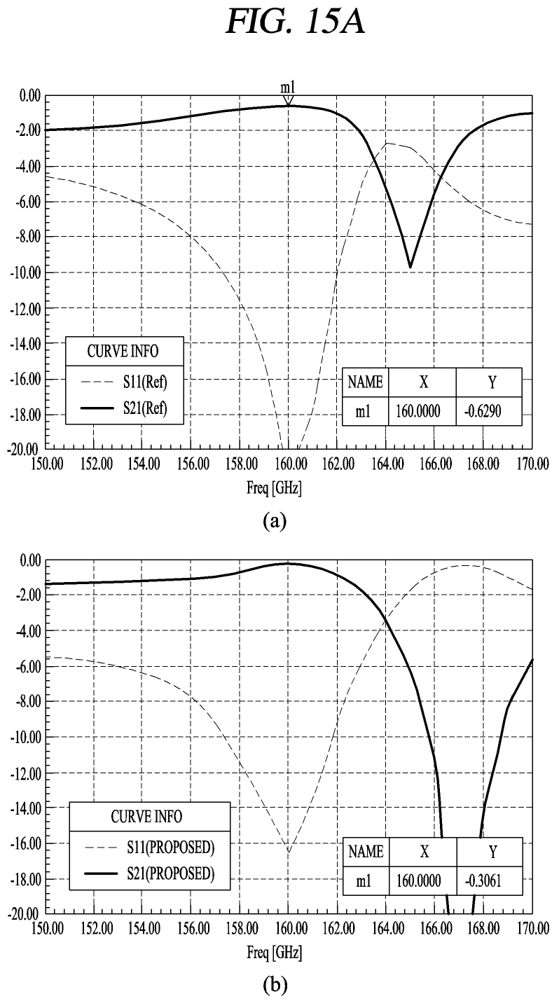

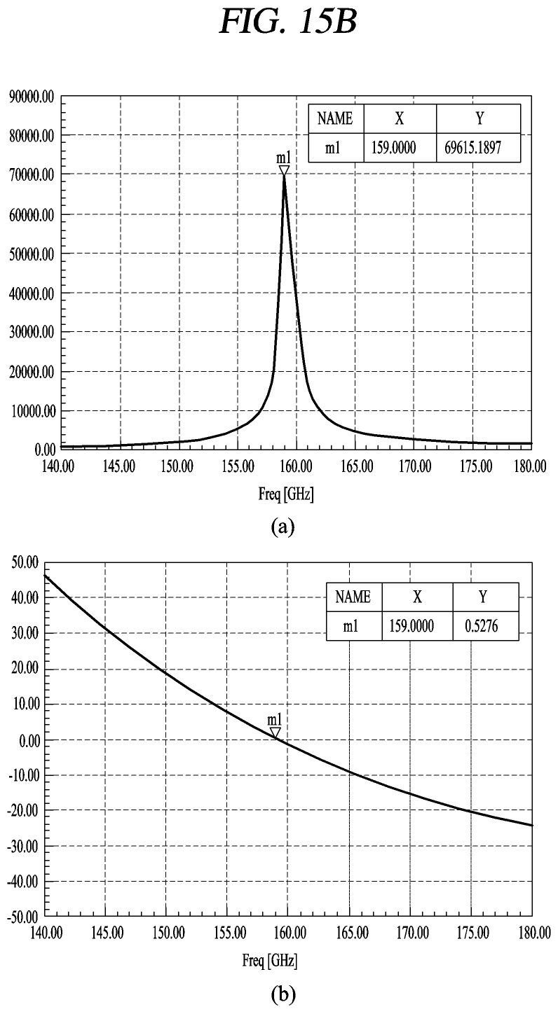

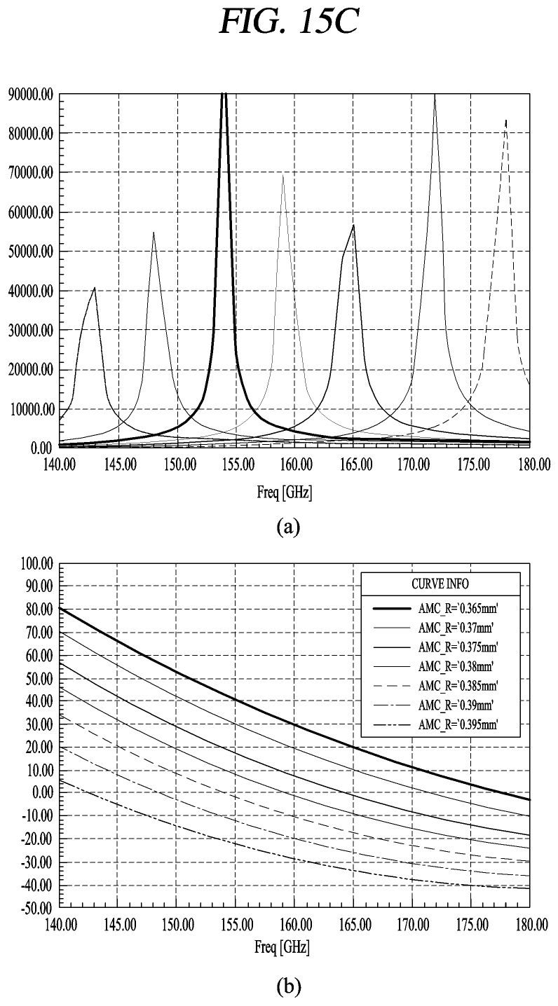

Hereinafter, a description will be given of electric field distributions in the waveguide of the microstrip-to-waveguide transition structure having the conductive surface 1150 implemented as the AMC according to the specification and a waveguide of a microstrip-to-waveguide transition structure having a signal conversion portion. Signal transmission characteristics according to the electric field distributions in the waveguides will also be compared and described. In this regard, FIG. 14 is a view of the electric field distribution of the microstrip-to-waveguide transition structure of FIGS. 9A and 9B. FIG. 15A compares reflection loss and insertion loss of the microstrip-to-waveguide transition structures of FIGS. 9A and 9B. FIG. 15B is a view of characteristic impedance and phase response curves of the microstrip-to-waveguide transition structure of FIG. 9B. FIG. 15C is a view of characteristic impedance and phase response curves according to changes in diameter in the unit cell structure of the AMC.

Referring to FIG. 9A and (a) of FIG. 14, in the antenna module 1100a having the signal conversion portion 1130, an electric field on the transmission line 1120 may be formed vertically in upper and lower directions. In some embodiments, the electric field transmitted into the waveguide 1110 through the transmission line 1120 and the signal conversion portion 1130 may form peaks at a certain period and may be formed in the horizontal direction. Accordingly, an RF signal transmitted into the waveguide 1110 may be transmitted to the lower region in the vertical direction.

Referring to FIG. 9A and (b) of FIG. 14, in the antenna module 1100 having the conductive surface 1150, an electric field on the transmission line 1120 may be formed vertically in the lower direction. In some embodiments, the electric field transmitted into the waveguide 1110 through the transmission line 1120 and the conductive surface 1150 may form peaks at a certain period and may be formed in the horizontal direction. Accordingly, an RF signal transmitted into the waveguide 1110 may be transmitted to the lower region in the vertical direction.

Referring to (a) and (b) of FIG. 14, a certain level of RF signal may be received on the transmission line 1120. In this regard, a certain level of electric field may be formed on the transmission line 1120 in the vertical direction. When the same level of electric field is formed on the transmission line 1120 of (a) and (b) of FIG. 14, an electric field peak inside the waveguide 1110 may be formed differently. As illustrated in (b) of FIG. 14, a lower electric field peak may be formed inside the waveguide 1110 of the antenna module 1100 in which the conductive surface 1150 is formed. Therefore, the signal transmission characteristics of the antenna module 1100 with the conductive surface 1150 of (b) of FIG. 14 may be superior to the signal transmission characteristics of the antenna module 1100 with the signal conversion portion 1130 of (a) of FIG. 14.

Referring to FIG. 9a, (a) of FIG. 14, and (a) of FIG. 15A, the antenna module 1100a having the signal conversion portion 1130 has a signal loss value of about 0.63 B at 160 GHz. Referring to FIG. 9B, (b) of FIG. 14, and (b) of FIG. 15A, the antenna module 1100 having the conductive surface 1150 has a signal loss value of about 0.3 dB at 160 GHz. Therefore, the antenna module 1100 having the conductive surface 1150 may have improved signal transmission characteristics by about 0.33 dB, compared to the antenna module 1100a having the signal conversion portion 1130.

Referring to FIG. 9B and (a) of FIG. 15B, the antenna module 1100 having the conductive surface 1150 has a high impedance characteristic of 69615Ω at 159 GHz. Referring to FIG. 9B, (b) of FIG. 15A, and (a) of FIG. 15B, the antenna module 1100 having the conductive surface 1150 is configured so that a signal is not transmitted in the upper direction of the waveguide 1100 at a certain bandwidth, for example, a bandwidth of 2 GHz, based on about 160 GHz. Therefore, the antenna module 1100 having the conductive surface 1150 may be configured to transmit a signal in the lower direction of the waveguide 1100 at a certain bandwidth based on about 160 GHz.

Referring to FIG. 9B and (a) of FIG. 15B, the antenna module 1100 having the conductive surface 1150 has a phase value of 0 degree at 159 GHz. Therefore, a signal incident on the conductive surface 1150 and a signal reflected from the conductive surface 1150 may have the same phase value, and the conductive surface 1150 may be configured as a perfect magnetic conductor (PMC). Accordingly, the microstrip-to-waveguide transition structure may be configured with only the conductive surface 1150 of a certain thickness or less without separately arranging a signal conversion portion in the upper region of the waveguide 1100.

Referring to FIGS. 10A,12, and 15C, the diameter AMC_{R} of the unit cell of the AMC corresponding to any one of the plurality of conductive patterns 1150c may have a value in a range of 365 um to 395 um with respect to 380 um. Referring to (a) of FIG. 15C, the unit cell of the AMC having the diameter AMC_{R} between 365 um and 395 μm has a peak characteristic impedance value between about 143 GHz and 178 GHz. Referring to (b) of FIG. 15C, the unit cell of the AMC having the diameter AMC_{R} between 365 um and 395 μm has a phase difference value of 0 degree between an incident signal and a reflected signal on the conductive surface 1150 between about 143 GHz and 178 GHz.

Referring to FIGS. 10A, 12, and 15C, the unit cell of the artificial magnetic conductor having the diameter AMC_{R} between 365 um and 395 μm may be implemented to have a resonant frequency of about 143 GHz to 178 GHz. In this regard, the diameter AMC_{R} of the unit cell has a significant impact on the change in the capacitance Cg value between adjacent conductive patterns. As the diameter AMC_{R} of the unit cell increases, the capacitance Cg value may increase, which may decrease the resonant frequency. Therefore, the diameter AMC_{R} of the unit cell may be adjusted depending on a target resonant frequency. The conductive surface 1150 may be manufactured in a coupling manner of attaching the conductive surface 1150 to the waveguide, which may allow the replacement with another conductive surface 1150 having the diameter AMC_{R} and reuse of the conductive surface 1150 when the RF frequency used is changed.

In another embodiment, a microstrip-to-waveguide transition structure may be designed in a wider frequency band by stacking a plurality of conductive patterns with different diameters AMC_{R} at a certain gap. For example, a microstrip-to-waveguide transition structure may be designed by stacking different conductive surfaces having diameters AMC_{R} (375 um, 380 um, and 385 um) at a certain gap.

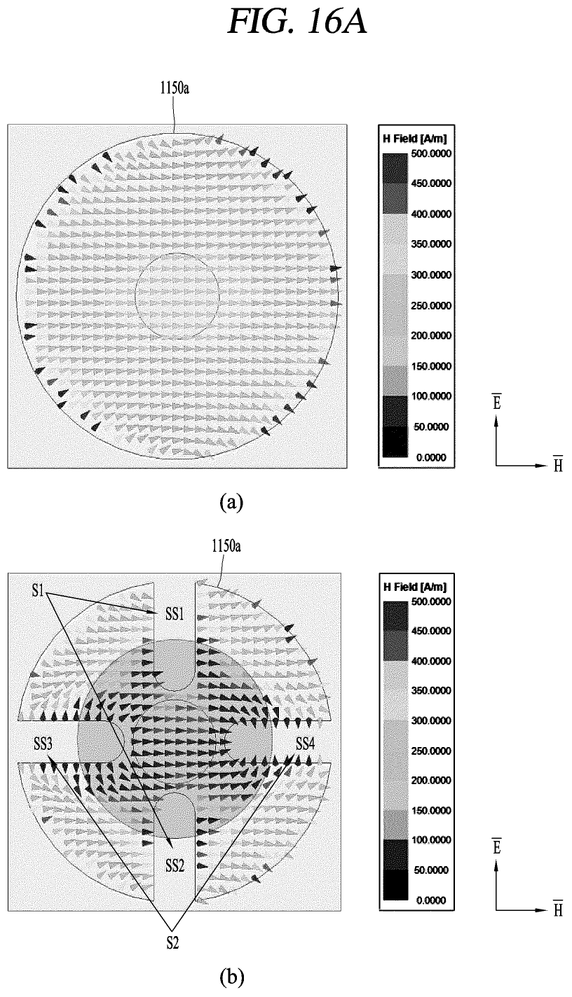

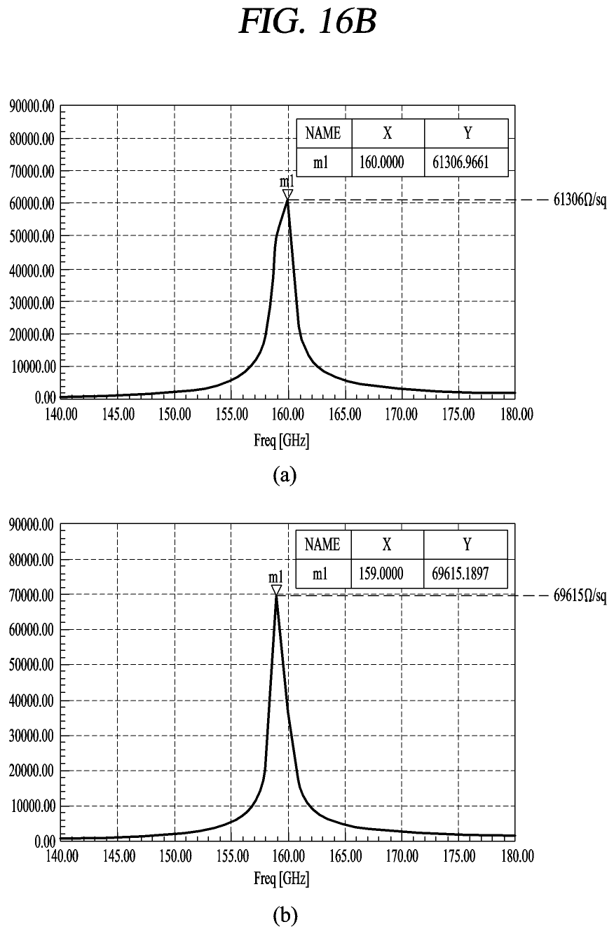

Hereinafter, a description will be given of the electrical characteristics according to the shape of the unit cell structure having the form of the AMC in the microstrip-to-waveguide transition structure having the conductive surface according to the specification. In this regard, FIG. 16A compares the current distributions formed on conductive patterns of unit cell structures according to presence or absence of a slot structure. FIG. 16B compares characteristic impedance values according to the shapes of the unit cell structures of FIG. 16A.

Referring to (a) of FIG. 16A, a conductive pattern 1150a may be configured so that any slot structure is not formed inside. The conductive pattern 1150a formed on one surface may be connected to a ground pattern formed on another surface through a via structure 1150v. A peak region of current distribution may be formed along an outer boundary of the conductive pattern 1150a.

Referring to FIGS. 13A and 13B and (b) of FIG. 16A, the conductive pattern 1150c may be configured such that slot structures, for example, first and second slot patterns S1 and S2 are formed in the conductive pattern 1150c. In this regard, the diameter of the conductive pattern 1150c may be formed in a certain range based on 380 um, but is not limited thereto. Width and length of the first and second slot patterns S1 and S2 may be formed in a certain range based on 50 um and in a certain range based on 130 um, respectively, but are not limited thereto.

The conductive pattern 1150c formed on the one surface may be connected to the ground pattern formed on the another surface through the via structure 1150v. The conductive pattern 1150c may include first to fourth sub-slots SS1, SS2, SS3, and SS4 formed on the upper side, lower side, one side, and another side based on the via structure 1150v. A peak region of current distribution may be formed along the boundaries of the first to fourth sub-slots SS1, SS2, SS3, and SS4. Accordingly, the peak region of the current distribution may also be formed in a central region of the conductive pattern 1150c adjacent to the boundaries of the first to fourth sub-slots SS1, SS2, SS3, and SS4.

In case that the slot shape is not applied to the unit cell structure of the AMC as illustrated in (a) of FIG. 16A, a magnetic field/current may have the strongest intensity at a conductor edge and have a periodic distribution. By adding the slot shape to the unit cell structure of the AMC as illustrated in FIGS. 13A and 13B and (b) of FIG. 16A, a magnetic flux (magnetic flux density) B flowing in a conductor per unit area may be concentrated on an inner center of the AMC, thereby generating a stronger current distribution. Mathematical Equation 4 expresses a relationship between magnetic field strength and induced current.

$$B = \frac{{μ}_{0} I}{2 π r} \qquad [ Mathematical Equation 4 ]$$

In this regard, AMC_{R} denotes the diameter of the unit cell structure of the AMC, and B denotes a magnetic flux density per unit area (Wb/m2). In some embodiments, po denotes permeability on a free space, I denotes current strength flowing in a conductive pattern, and r denotes a distance from the center of the conductive pattern.

Referring to Mathematical Equation 1 and FIG. 16A, as a stronger magnetic flux is formed on the conductive surface of the AMC, a stronger current may be induced on the conductive surface. Therefore, the slot shape may be arranged on the conductive surface so that the strong magnetic flux is formed on the conductive surface of the AMC. Accordingly, an inductance component may increase and higher impedance may be implemented in the unit cell structure. In other embodiments, the higher characteristic impedance may allow for reduction of leakage current, which may increase signal conversion efficiency.

Referring to (a) of FIG. 16A and (a) of FIG. 16B, the characteristic impedance value of the unit cell structure of the conductive pattern 1150a without a slot formed therein may have a value of 61306 W/sq at a resonant frequency of 160 GHz. Referring to (b) of FIG. 16A and (b) of FIG. 16B, the characteristic impedance value of the unit cell structure of the conductive pattern 1150c having the first and second slots S1 and S2 formed therein may have a value of 69615 W/sq at a resonant frequency of 159 GHz. The characteristic impedance value of the conductive pattern 1150c having the first and second slots S1 and S2 formed therein may be greater than the characteristic impedance value of the conductive pattern 1150 without slots. In this regard, in case of having a higher characteristic impedance value, leakage current to the upper region of the conductive pattern, i.e., the upper region of the waveguide may be reduced. Therefore, the conductive surface having the conductive pattern 1150c with the first and second slots S1 and S2 therein may have higher signal conversion efficiency.

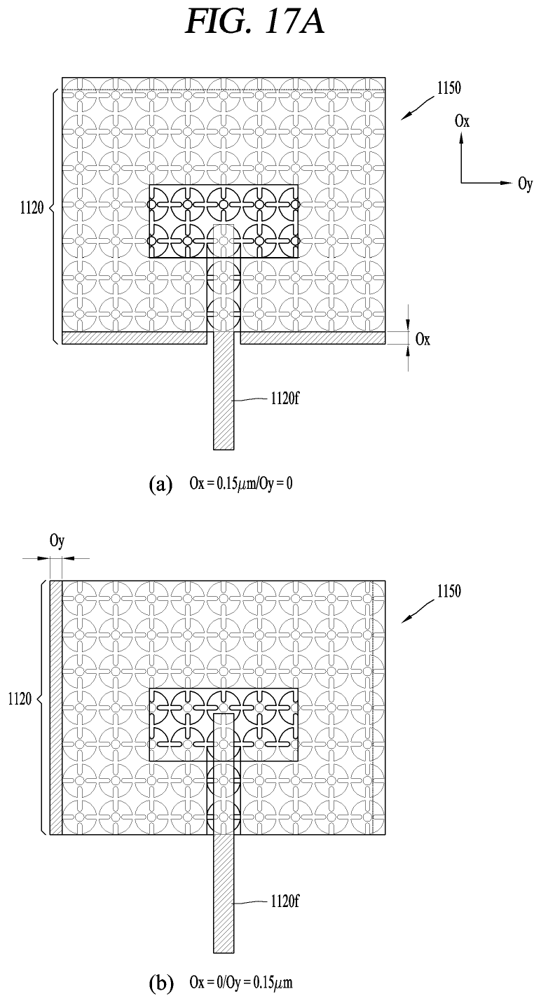

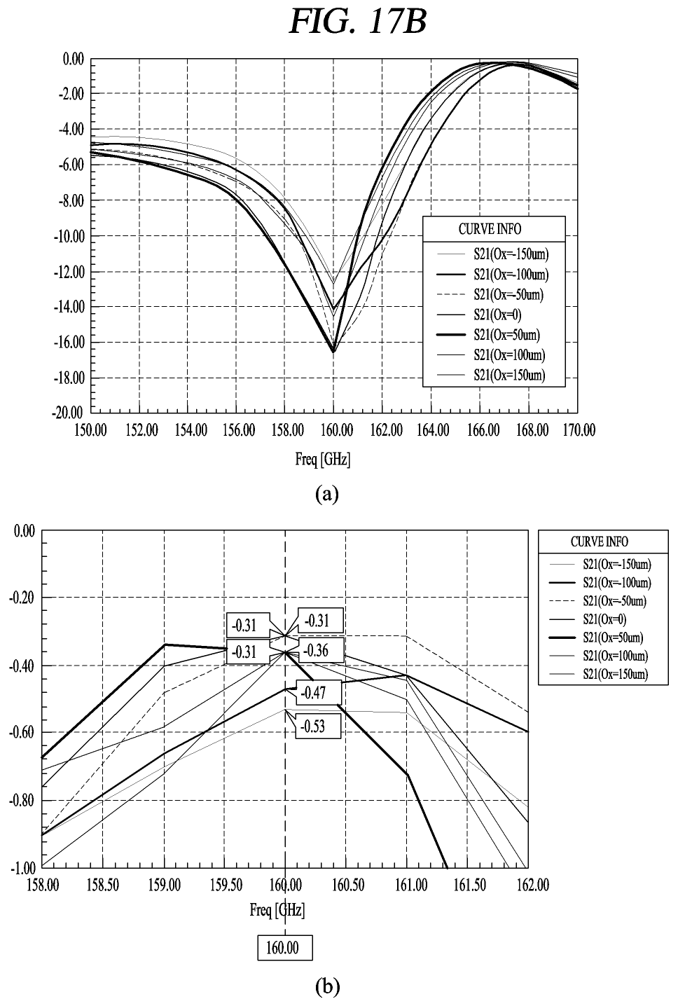

Hereinafter, a description will be given of electrical characteristics according to an offset arrangement of the unit grids of the conductive surface in the microstrip-to-waveguide transition structure having the conductive surface according to the specification. In this regard, FIG. 17A is a view of a structure in which unit grids of a conductive surface are offset in vertical and horizontal directions with respect to an open area of a waveguide. FIGS. 17B and 17C are views of changes in reflection coefficient and transmission coefficient characteristics according to changes in offset interval in an x-axis direction and a y-axis direction.

Referring to FIG. 8B, FIG. 11B, and (a) of FIG. 17A, the conductive surface 1150 may be arranged offset by a certain gap Ox in the x-axis direction. Referring to FIG. 11B and (b) of FIG. 17A, the conductive surface 1150 may be arranged offset by a certain gap Oy in the y-axis direction. Referring to (a) of FIG. 17A and (b) of FIG. 17B, the conductive surface 1150 may be offset by 150 um in maximum in the x-axis direction or the y-axis direction to overlap the upper region of the waveguide 1110.

In this regard, the conductive surface 1150 of the AMC having a very thin thickness may be used by being bonded to a portion where the signal pattern 1120f of the microstrip-shaped transmission line and the waveguide 1110 come into contact with each other. Therefore, a performance deviation due to misalignment during bonding between the conductive surface 1150 and the waveguide 1110 must be maintained below a certain level. Referring to FIG. 11B, (a) of FIG. 17A, and (b) of FIG. 17A, the changes in electrical characteristics may be analyzed under assumption that the conductive surface 1150 is attached with errors of 50 um, 100 μm, and 150 um in the x-axis direction or the y-axis direction from a fixed position.

Referring to FIG. 11B, FIG. 17A, and (a) of FIG. 17B, the unit cell structure of the AMC may be constantly maintained at 160 GHz even when the offset gap Ox in the x-axis direction changes in the range from −150 um to +150 um. As the offset gap Ox changes in the range from −150 um to +150 um, a reflection coefficient value at a resonant frequency may change in a certain range. Accordingly, even if the offset interval Ox changes in the range from −150 um to +150 um, a signal may be transmitted from the signal pattern 1120f of the microstrip-shaped transmission line to the open area in the waveguide 1110 through the conductive surface 1150.

Referring to FIG. 11B, FIG. 17A, and (b) of FIG. 17B, a resonant frequency may be constantly maintained at 160 GHz even when the offset gap Ox in the x-axis direction of the unit cell structure of the AMC changes in the range from −150 um to +150 um. As the offset gap Ox changes in the range from −150 um to +150 um, the transmission coefficient value at the resonant frequency may have a value in a certain range, for example, between −0.31 dB and −0.53 dB. Accordingly, even if the offset interval Ox changes in the range from −150 um to +150 um, a signal may be transmitted from the signal pattern 1120f of the microstrip-shaped transmission line to the open area in the waveguide 1110 through the conductive surface 1150.

Referring to FIG. 11B, FIG. 17A, and (a) of FIG. 17C, a resonant frequency may be constantly maintained at 160 GHz even when the offset gap Oy in the y-axis direction of the unit cell structure of the AMC changes up to 150 um. As the offset gap Ox changes in the range from −150 um to +150 um, a reflection coefficient value at the resonant frequency may change in a certain range. Accordingly, even if the offset interval Oy changes up to 150 um, a signal may be transmitted from the signal pattern 1120f of the microstrip-shaped transmission line to the open area in the waveguide 1110 through the conductive surface 1150.

Referring to FIG. 11B, FIG. 17A, and (b) of FIG. 17C, the resonant frequency may be constantly maintained at 160 GHz even when the offset gap Oy in the y-axis direction of the unit cell structure of the AMC changes up to 150 um. As the offset gap Oy changes up to 150 um, a transmission coefficient value at a resonant frequency may have a value in a certain range, for example, between −0.31 dB and −0.46 dB. Accordingly, even if the offset interval Oy changes up to 150 um, a signal may be transmitted from the signal pattern 1120f of the microstrip-shaped transmission line to the open area in the waveguide 1110 through the conductive surface 1150. The change in signal conversion efficiency of about 0.22 dB may occur for 75% of alignment error relative to a radius of 190 um of the AMC. This may provide a performance deviation insensitive to the alignment errors in case of attaching the conductive surface 1150 to the waveguide 1110.

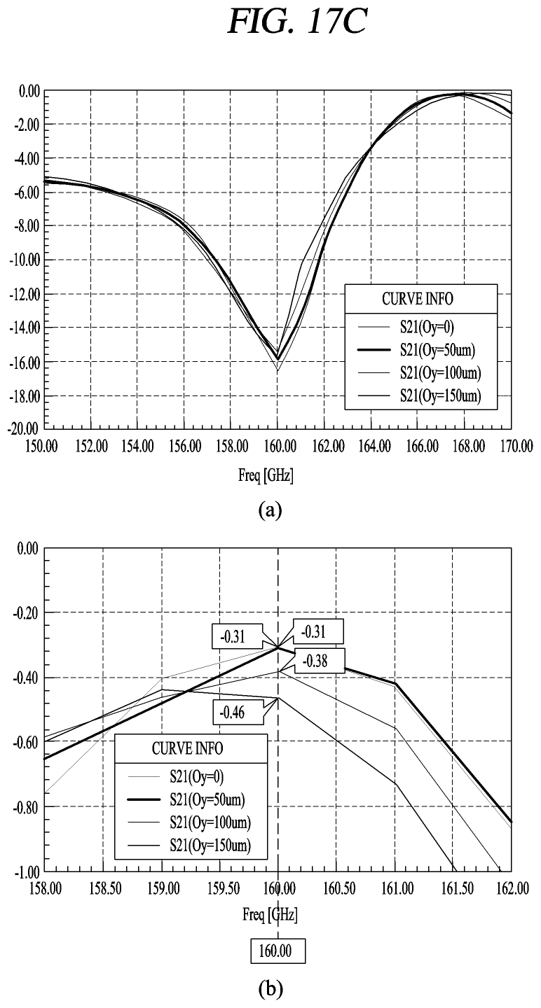

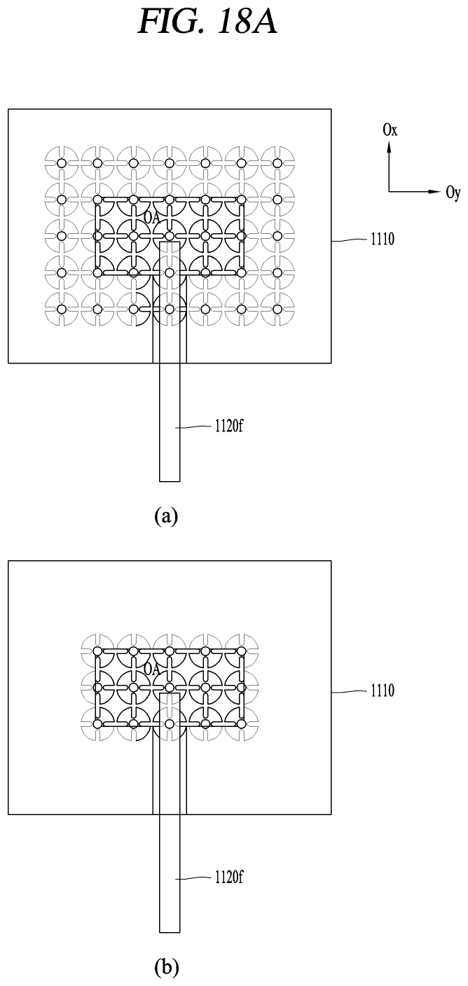

In some embodiments, in a microstrip-to-waveguide transition structure having a conductive surface according to the specification, signal transmission efficiency may be maintained in a certain range even though the number of unit grids of the conductive surface is reduced. FIG. 18A is a view of a transition structure in which the unit cell structures within the conductive surface 1150 form 5×7 array and 3×5 array. In this regard, the unit cell structure in the conductive surface 1150 of FIG. 11B may be configured in a 7×9 array. FIG. 18B is a view of reflection coefficient and transmission coefficient characteristics of transition structures with 7×9 array, 5×7 array, and 3×5 array.

Referring to FIG. 11B and (a) of FIG. 18A, a first length in one axial direction of a region where the conductive surface 1150 is arranged may be at least twice a second length in the one axial direction of the open area OA. A first width in another axial direction of the region where the conductive surface 1150 is arranged may be at least twice a second width in the another axial direction of the open area OA. In this regard, the one axial direction of the region where the conductive surface 1150 is arranged may be an E-plane direction that matches an electric field direction inside the waveguide 1110. The another axial direction of the region where the conductive surface 1150 is arranged may be an H-plane direction perpendicular to the electric field direction inside the waveguide 1110.

Referring to FIG. 11B, the unit cell structure in the conductive surface 1150 may be configured in a 7×9 array. The conductive surface 1150 of the 7×9 array may have a size of 2.8×3.6 mm. Referring to (a) of FIG. 18A, the unit cell structure in the conductive surface 1150 may be configured in a 5×7 array. The conductive surface 1150 of the 5×7 array may have a size of 2.0×2.8 mm.

Accordingly, the selection of the number of arrays of the unit cell structure of the AMC may be implemented to have a length at least twice the length of the E-plane and H-plane of the open area of the waveguide. Accordingly, the AMC in the conductive surface 1150 may be designed to have stable electrical characteristics, i.e., signal transmission characteristics.

In this regard, the waveguide 1110 may be WR-06 as a standard waveguide of a D-band, which is a terahertz (THz) band. The conductive surface 1150 of the AMC may be applied to the waveguide 1110 of the D-band. The size of the open area OA on the E-plane/H-plane of the waveguide 1110 of the D-band may be set to 0.8255×1.651 mm, but is not limited thereto. In some embodiments, the number of arrays having at least a certain length may be determined to cover the open area OA of the waveguide depending on the number of arrays of the unit cell structure.

The 5×7 array in (a) of FIG. 18A may have a length at least twice the length of the open area OA of the waveguide. The signal conversion efficiency may drastically deteriorate when the number of arrays of the unit cell structure is smaller than the 5×7 array. In other embodiments, stable signal conversion efficiency of a similar performance level may be achieved when the number of arrays of the conductive surface 1150 is set to be at least the 5×7 array.

Referring to (b) of FIG. 18A, a first length in one axial direction of a region where the conductive surface 1150 is arranged may be formed to be longer than the second length in the one axial direction of the open area OA and equal to or shorter than twice the second length. A first width in another axial direction of the region where the conductive surface 1150 is arranged may be formed to be greater than a second width in the another axial direction of the open area OA and equal to or smaller than twice the second width. The unit cell structure in the conductive surface 1150 may be configured in a 3×5 array. The conductive surface 1150 of the 3×5 array may have a size of 1.2×2.o mm.

Referring to FIG. 11B, FIG. 18A, and (a) of FIG. 18B, the antenna modules having the conductive surfaces 1150 of the 7×9 array and 5×7 array may have reflection coefficient characteristics of −15 dB or less at a center frequency of 160 GHz. In other embodiments, the antenna module having the conductive surface 1150 of the 3×5 array may have a reflection coefficient characteristic of at least −15 dB at a resonant frequency of 160 GHz, which may increase the amount of reflected signals.

Referring to FIG. 11B, FIG. 18A, and (b) of FIG. 18B, the antenna modules having the conductive surfaces 1150 of the 7×9 array and 5×7 array may have transmission coefficient characteristics of −0.31 dB and −0.39 dB at the center frequency of 160 GHz. In other embodiments, the antenna module having the conductive surface 1150 of the 3×5 array may have a transmission coefficient characteristic of −1.91 dB at the resonant frequency of 160 GHz, causing signal loss of at least 1.5 dB compared to the conductive surface 1150 of the 5×7 array. Therefore, signal conversion loss may be maintained below a certain level in case that the number of arrays in the conductive surface 1150 is selected to have a length more than twice the length on the E-plane/H-plane of the open area OA of the waveguide 1110. It may be confirmed that the signal conversion loss coefficient is maintained below a certain level in case that the number of arrays in the conductive surface 1150 is 5×7 or more.

An antenna module to which the microstrip-to-waveguide transition structure disclosed herein is applied may be configured as an array antenna in an electronic device. In this regard, FIG. 19A is a view of a structure in which an antenna module having a first type antenna and a second type antenna as array antennas is arranged in an electronic device. FIG. 19B is an enlarged view of a plurality of array antenna modules.

Referring to FIGS. 1 to 19B, the array antenna may include a first array antenna module 1100-1, and a second array antenna module 1100-2 spaced apart from the first array antenna module 1100-1 by a certain gap in a first horizontal direction. In some embodiments, the number of array antennas is not limited to two, but may be at least three as illustrated in FIG. 19B. Therefore, the array antenna may include a first array antenna module 1100-1 to a third array antenna module 1100-3.

The processor 1400 of FIGS. 5 to 6C may control the first array antenna module 1100-1 and the second array antenna module 1100-2 to generate a first beam and a second beam in a first direction and a second direction, respectively. For example, the processor 1400 may control the first array antenna module 1100-1 to generate the first beam horizontally in the first direction. Also, the processor 1400 may control the second array antenna module 1100-2 to generate the second beam horizontally in the second direction. In this regard, the processor 1400 may perform MIMO using the first beam of the first direction and the second beam of the second direction.

The processor 1400 may generate a third beam in a third direction using the first and second array antenna modules 1100-1 and 1100-2. In this regard, the processor 1400 may control the transceiver circuit 1250 to synthesize signals received through the first and second array antenna modules 1100-1 and 1100-2. Also, the processor 1400 may control the transceiver circuit 1250 to distribute signals transmitted to the first and second array antenna modules 1100-1 and 1100-2 into each antenna element. The processor 1400 may perform beamforming using the third beam which has a beam width narrower than those of the first beam and the second beam.

In some embodiments, the processor 1400 may perform MIMO using the first beam of the first direction and the second beam of the second direction, and perform beamforming using the third beam having the narrower beam width than those of the first beam and the second beam. In relation to this, when a first signal and a second signal received from other electronic devices in the vicinity of the electronic device have qualities lower than or equal to a threshold value, the processor 1400 may perform beamforming using the third beam.

The number of elements of the array antenna may be two, three, four, and the like as illustrated, but is not limited thereto. For example, the number of elements of the array antenna may be expanded to two, four, eight, sixteen, and the like. Therefore, the array antenna may be configured as 1×2, 1×3, 1×4, 1×5, . . . , 1×8 array antenna.

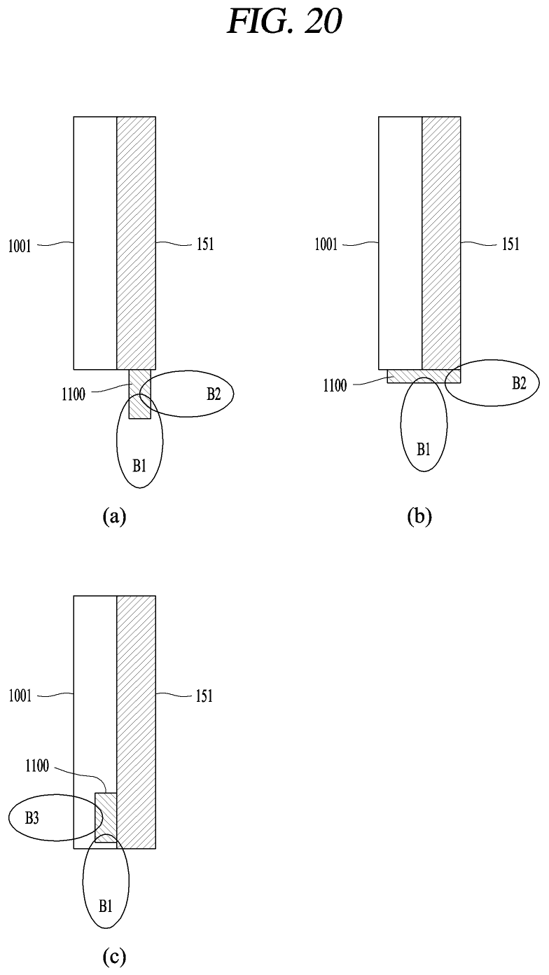

FIG. 20 is a view of an antenna module coupled in a different coupling structure at a specific position of an electronic device according to embodiments. Referring to (a) of FIG. 20, the antenna module 1100 may be arranged in the lower region of the display 151 to be substantially horizontal to the display 151. Accordingly, a beam B1 may be generated in a lower direction of the electronic device through any one array antenna of the plurality of array antenna modules. In some embodiments, another beam B2 may be generated in a front direction of the electronic device through another array antenna of the plurality of array antenna modules.

Referring to (b) of FIG. 20, the array antenna module 1100 may be arranged in the lower region of the display 151 to be substantially perpendicular to the display 151. Accordingly, a beam B2 may be generated in the front direction of the electronic device through any one array antenna of the plurality of array antenna modules. In some embodiments, another beam B1 may be generated in the lower direction of the electronic device through another array antenna of the plurality of array antenna modules.

Referring to (c) of FIG. 20, the antenna module 1100 may be arranged, for example, inside a rear case 1001 corresponding to a mechanism structure. The antenna module 1100 may be arranged inside the rear case 1001 to be substantially parallel to the display 151. Accordingly, a beam B2 may be generated in the lower direction of the electronic device through any one array antenna of the plurality of array antenna modules. In some embodiments, another beam B3 may be generated in a rear direction of the electronic device through another array antenna of the plurality of array antenna modules.

Hereinafter, an electronic device with an antenna module having a conductive surface as an artificial magnetic conductor (AMC) according to another aspect of the specification will be described with reference to FIGS. 1 to 20.

An electronic device 1000 disclosed herein is not limited to a display device. The electronic device 1000 may be implemented as at least one of a mobile terminal, a stationary terminal, and a vehicle that perform wireless communication in a terahertz band. The electronic device 1000 may include an array antenna module 1100 and a transceiver circuit 1250.

The array antenna module 1100 may be implemented as an antenna element, for example, a waveguide 1110, which operates in a terahertz band, for example, a band of 160 GHz. The waveguide 1110 may have an open area OA formed to radiate a signal in the upper/lower direction or the side direction of a multi-layer substrate. In this regard, it may be necessary to connect the transceiver circuit 1250 and the waveguide 1110, which are formed on the multi-layer substrate corresponding to a PCB, to a transmission line 1120 in the millimeter wave or terahertz band (e.g., 10 GHz to 300 GHz).

The array antenna module 1100 may be configured to perform beamforming by arranging a plurality of antenna elements to be spaced apart at certain gaps to radiate a signal of a certain frequency band. The transceiver circuit 1250 may be operably coupled to the array antenna module 1100. The transceiver circuit 1250 may be configured to transmit the signal of the specific frequency band to the array antenna module 1100.

The array antenna module 1100 may include a waveguide 1110 configured to have an open area OA at one end of the waveguide 1110 in a longitudinal direction so that the signal of the specific frequency band is transmitted. As illustrated in FIGS. 7B, 8B, 19A, and 19B, the plurality of antenna elements may be configured such that the radiation regions RR of the waveguide 1110 are spaced apart by a certain gap. The waveguide 1110 may have the radiation regions RR formed at another end in the longitudinal direction to be spaced apart by a certain gap so that the signal of the specific frequency band is radiated.

The array antenna module 1100 may include a first dielectric substrate arranged in the open area OA of the waveguide 1110. The array antenna module 1100 may further include a transmission line 1120 arranged in an upper region of the first dielectric substrate 1010a. The transmission line 1120 may include a signal pattern 1120f, a first ground pattern 1120g, and a second open area OA2.

The array antenna module 1100 may include a second dielectric substrate 1010b arranged in the upper region of the first dielectric substrate 1010a. The array antenna module 1100 may further include a conductive surface 1150 which includes a plurality of conductive patterns 1150c arranged on another surface of the second dielectric substrate 1010b in one axial direction and another axial direction. A second ground pattern 1150g may be formed on one surface of the second dielectric substrate 1010b. The array antenna module 1100 may further include a via structure 1150v configured to vertically connect a plurality of conductive patterns 1150c of the conductive surface 1150 to the second ground pattern 1150g.

In some embodiments, the antenna module 1100 may further include a second via structure 1160v configured to vertically connect the second ground pattern 1150g and a third ground pattern 1160g. A plurality of vertical vias constituting the second via structure 1160v may be configured to connect the first ground pattern 1120g and the third ground pattern 1160g in an outer region of the second open area OA2 and a third open area OA3.

A first length in one axial direction of a region where the conductive surface 1150 is arranged may be at least twice a second length in the one axial direction of the open area OA. A first width in another axial direction of the region where the conductive surface 1150 is arranged may be at least twice a second width in the another axial direction of the open area OA.

An artificial magnetic conductor (AMC) including the plurality of conductive patterns 1150c may include a first slot pattern S1 and a second slot pattern S2. The first slot pattern S1 may be formed in an electric field direction of a signal, which is one axial direction based on a center point where the vertical via is connected. The second slot pattern S2 may be formed in a magnetic field direction of a signal, which is another axial direction based on the center point where the vertical via is connected. An inductance L may be induced to correspond to a current, which is formed in the second ground pattern 1150g between adjacent vertical vias of the via structure. A capacitance Cg may be induced between the second slot patterns S2 of adjacent conductive patterns in the electric field direction among the plurality of conductive patterns 1150c. A first capacitance Cp1 may be induced in the first slot pattern S1. A second capacitance Cp2 may be induced in the second slot pattern S2. Accordingly, the resonant frequency fr of the AMC may be set as expressed in Mathematical Equation 3.

The plurality of dielectric substrates may be configured to be stacked on each other. One surface of the first dielectric substrate 1010a may be located to oppose the second dielectric substrate 1010b on which the conductive surface 1150 is formed. Another surface of the first dielectric substrate 1010a may be arranged to oppose the open area OA of the waveguide 1110. The third ground pattern 1160g formed on the another surface of the first dielectric substrate 1010a may have a third open area OA3 formed to correspond to the open area OA of the waveguide 1110.

A first length of the open area OA of the waveguide 1110 in the one axial direction and a second length of the second open area OA2 of the transmission line 1120 in the one axial direction may be formed to be the same. A third length of the third open area OA3 of the first dielectric substrate 1010a in the one axial direction may also be formed to be the same as the first length and the second length. A first width of the open area OA of the waveguide 1110 in the another axial direction of and a second width of the second open area OA2 of the transmission line 1120 in the another axial direction may be formed to be the same. A third width of the third open area OA3 of the first dielectric substrate 1010a in the another axial direction may also be formed to be the same as the first width and the second width. The one axial direction and the another axial direction may be formed in an electric field direction and a magnetic field direction of a signal transmitted through the waveguide 1110.

In some embodiments, a unit cell of the plurality of conductive patterns 1150c constituting the conductive surface 1150 may include a conductive pattern 1151c, a first slot pattern S1, and a second slot pattern S2. The conductive pattern 1151c may be formed in a circular shape to correspond to the circular shape of the vertical vias constituting the via structure 1150v. The first slot pattern S1 may be formed on the conductive pattern 1151c to be symmetrical to the vertical via in the one axial direction. The second slot pattern S2 may be formed on the conductive pattern 1151c to be symmetrical to the vertical via in the another axial direction. The first slot pattern S1 may include a first sub-slot SS1 and a second sub-slot SS2 formed in upper and lower regions of the vertical via. The second slot pattern S2 may include a third sub-slot SS3 and a fourth sub-slot SS4 formed in left and right regions of the vertical via.

So far, the antenna module including the microstrip-to-waveguide transition structure operating in the terahertz band, and the electronic device having the same have been described. Hereinafter, technical effects of an antenna module having a microstrip-to-waveguide transition structure operating in a terahertz band, and an electronic device having the same will be described.

According to an embodiment, ultra-high-speed 6G wireless communication based on a terahertz band may be enabled through an antenna module and an electronic device having the same.

According to an embodiment, signal conversion efficiency in a microstrip-to-waveguide transition structure may be improved by using a conductive surface structure of a metamaterials-based artificial magnetic conductor.

According to an embodiment, a height of a microstrip-to-waveguide transition structure may be minimized by providing a metamaterial-based attachable ultra-thin microstrip-to-waveguide transition structure.

According to an embodiment, a change in electrical characteristics of an antenna module due to an alignment error of a microstrip-to-waveguide transition structure may be minimized upon an occurrence of an alignment error of an AMC-based unit cell structure.

According to an embodiment, AMC-based unit cell structures may be formed in an arrangement structure in one axial direction and another axial direction, thereby providing a high-output, low-loss transmission structure in a millimeter wave band or higher.

Further scope of applicability of the disclosure will become apparent from the following detailed description. It should be understood, however, that the detailed description and specific examples, such as the preferred embodiments, are given by way of illustration only, because various changes and modifications within the technical idea and scope of the disclosure will be apparent to those skilled in the art.

The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller of the terminal. Therefore, the detailed description should not be limitedly construed in all of the aspects, and should be understood to be illustrative. Therefore, all changes and modifications that fall within the metes and bounds of the claims, or equivalents of such metes and bounds are therefore intended to be embraced by the appended claims.

1. An antenna module comprising:
a waveguide configured to have an open area at one end in a longitudinal direction so that a signal of a specific frequency band is transmitted, wherein the waveguide comprises radiation regions formed at another end in the longitudinal direction so that the signal is radiated;
a first dielectric substrate arranged in the open area of the waveguide;
a transmission line formed on one surface of the first dielectric substrate and comprising a signal pattern, a first ground pattern, and a second open area; and
a second dielectric substrate arranged in an upper region of the first dielectric substrate, wherein the second dielectric substrate comprises a second ground pattern on one surface of the second dielectric substrate;
a conductive surface comprising a plurality of conductive patterns arranged on another surface of the second dielectric substrate in one axial direction and another axial direction; and
a via structure configured to vertically connect the plurality of conductive patterns of the conductive surface and the second ground pattern,
wherein a first length in the one axial direction of a region where the conductive surface is arranged, is at least twice longer than a second length in the one axial direction of the open area, and
a first width in the another axial direction of the region where the conductive surface is arranged is at least twice wider than a second width in the another axial direction of the open area,
wherein the number of arrays of a unit cell of the conductive surface is set to be at least 5×7 array.

2. The antenna module of claim 1, wherein an artificial magnetic conductor (AMC) comprising the plurality of conductive patterns comprises:
a first slot pattern formed in an electric field direction of the signal, as the one axial direction, based on a center point to which a vertical via of the via structure is connected; and
a second slot pattern formed in a magnetic field direction of the signal, as the another axial direction, based on the center point to which the vertical via is connected,
an inductance L is induced to correspond to a current formed in the second ground pattern between adjacent vertical vias of the via structure,
a capacitance Cg is induced between the second slot patterns of the conductive patterns adjacent in the electric field direction, among the plurality of conductive patterns,
a first capacitance Cp1 is induced in the first slot pattern,
a second capacitance Cp2 is induced in the second slot pattern, and
a resonant frequency fr of the AMC is set to
$${f}_{r} = \frac{1}{2 π \sqrt{( L ( {C}_{g +} {C}_{p 1 +} {C}_{p 2} )}} .$$

3. The antenna module of claim 1, wherein one surface of the first dielectric substrate is arranged to oppose the second dielectric substrate on which the conductive surface is formed,
another surface of the first dielectric substrate is arranged to oppose the open area of the waveguide, and
a third ground pattern formed on the another surface of the first dielectric substrate has a third open area formed to correspond to the open area of the waveguide.

4. The antenna module of claim 3, wherein a first length of the open area of the waveguide in the one axial direction, a second length of the second open area of the transmission line in the one axial direction, and a third length of the third open area of the first dielectric substrate in the one axial direction are formed identically,
a first width of the open area of the waveguide in the another axial direction, a second width of the second open area of the transmission line in the another axial direction, and a third width of the third open area of the first dielectric substrate in the another axial direction are formed identically,
the one axial direction and the another axial direction are formed in an electric field direction and a magnetic field direction of a signal transmitted through the waveguide.

5. The antenna module of claim 3, further comprising a second via structure configured to vertically connect the second ground pattern and the third ground pattern,
wherein a plurality of vertical vias constituting the second via structure are configured to connect the first ground pattern and the third ground pattern in outer regions of the second open area and the third open area.

6. The antenna module of claim 1, wherein the first ground pattern is arranged spaced apart from the signal pattern on one side and another side of the signal pattern of the transmission line,
one end of the signal pattern is electrically connected to a transceiver circuit arranged on a third dielectric substrate that is arranged separately from the first dielectric substrate,
the first ground pattern is formed to surround another end of the signal pattern and the one side and the another side of the signal pattern, and
the another end of the signal pattern is formed in the second open area, so that a signal transmitted from the transceiver circuit is transmitted into the waveguide and radiated through a radiation region of the waveguide.

7. The antenna module of claim 2, wherein the unit cell of each of the plurality of conductive patterns comprises:
a conductive pattern formed in a circular shape to correspond to a circular shape of the vertical via constituting the via structure;
a first slot pattern formed on the conductive pattern to be symmetrical to the vertical via in the one axial direction; and
a second slot pattern formed on the conductive pattern to be symmetrical to the vertical via in the another axis direction,
the first slot pattern comprises a first sub-slot and a second sub-slot formed in upper and lower regions of the vertical via, and
the second slot pattern comprises a third sub-slot and a fourth sub-slot formed in left and right regions of the vertical via.

8. The antenna module of claim 7, wherein the first sub-slot through the fourth sub-slot are formed with a first length through a fourth length in the one axial direction and the another axial direction,
the first sub-slot through the fourth sub-slot are formed with a first width through a fourth width in the one axial direction and the another axial direction,
the first length through the fourth length are set to a same length, and
the first width through the fourth width are set to a same width.

9. The antenna module of claim 8, wherein the first length through the fourth length are smaller than a difference between a first radius of the conductive pattern and a second radius of a connection region of the vertical via connected to the conductive pattern.

10. The antenna module of claim 9, wherein end portions of the first sub-slot to the fourth sub-slot, adjacent to the vertical via, are formed in a semicircular shape,
a third radius of the end portions of the first sub-slot to the fourth sub-slot having the semicircular shape, is smaller than the second radius of the vertical via, and
the first width to the fourth width of the first sub-slot to the fourth sub-slot are smaller than the second radius of the vertical via.

11. The antenna module of claim 7, wherein the conductive surface comprises at least 7 unit cells arranged in the one axial direction, and at least 5 unit cells arranged in the another axial direction.

12. The antenna module of claim 7, wherein a first unit cell, a second unit cell, and a third unit cell, which are adjacent in the one axial direction, comprise a first vertical via, a second vertical via, and a third vertical via, respectively,
a first current path is formed along a conductive pattern of the first unit cell, the first vertical via, the second ground pattern, the second vertical via, and a conductive pattern of the second unit cell,
a second current path is formed along a conductive pattern of the third unit cell, the third vertical via, the second ground pattern, the first vertical via, and the conductive pattern of the first unit cell, and
a first direction of the first current path and a second direction of the second current path are opposite to each other.

13. The antenna module of claim 7, wherein a first unit cell and a second unit cell, adjacent in the one axial direction, are arranged spaced apart from each other by at least a first gap, and
the first unit cell and a fourth unit cell, adjacent in the another axial direction, are arranged spaced apart from each other by at least a second gap.

14. The antenna module of claim 13, wherein the first slot patterns of the first unit cell and the second unit cell in the one axial direction are configured to be interconnected, and
the second slot patterns of the first unit cell and the fourth unit cell in the another axial direction are configured to be interconnected.

15. The antenna module of claim 14, wherein a size of the unit cell in the one axial direction and the another axial direction is formed in a range of 10 um based on 380 um,
the first unit cell and the second unit cell are arranged spaced apart from each other in a range of 10 to 20 um in the one axial direction,
the first unit cell and the second unit cell are arranged spaced apart from each other in a range of 10 to 20 um in the another axial direction, and
the signal of the specific frequency band transmitted from the waveguide to the signal pattern of the transmission line is a signal of a frequency band ranging from 158 GHz to 162 GHz.

16. An electronic device comprising:
an array antenna module configured to perform beamforming by radiating a signal of a specific frequency band; and
a transceiver circuit operably coupled to the array antenna module and configured to transmit the signal of the specific frequency band to the array antenna module,
wherein the array antenna module comprises:
a waveguide configured to have an open area at one end in a longitudinal direction so that the signal of the specific frequency band is transmitted, wherein the waveguide comprises radiation regions formed at another end in the longitudinal direction so that the signal is radiated;
a first dielectric substrate arranged in the open area of the waveguide;
a transmission line arranged in an upper region of the first dielectric substrate and comprising a signal pattern, a first ground pattern, and a second open area;
a second dielectric substrate arranged in the upper region of the first dielectric substrate,
wherein the second dielectric substrate comprises a second ground pattern on one surface of the second dielectric substrate;
a conductive surface comprising a plurality of conductive patterns arranged on another surface of the second dielectric substrate in one axial direction and another axial direction; and
a via structure configured to vertically connect the plurality of conductive patterns of the conductive surface and the second ground pattern,
wherein a first length in the one axial direction of a region where the conductive surface is arranged, is at least twice longer than a second length in the one axial direction of the open area, and
a first width in the another axial direction of the region where the conductive surface is arranged is at least twice wider than a second width in the another axial direction of the open area,
wherein the number of arrays of a unit cell of the conductive surface is set to be at least 5×7 array.

17. The electronic device of claim 16, wherein an artificial magnetic conductor (AMC) comprising the plurality of conductive patterns comprises:
a first slot pattern formed in an electric field direction of the signal, as the one axial direction, based on a center point to which the vertical via is connected; and
a second slot pattern formed in a magnetic field direction of the signal, as the another axial direction, based on the center point to which a vertical via of the via structure is connected,
an inductance L is induced to correspond to a current formed in the second ground pattern between adjacent vertical vias of the via structure,
a capacitance Cg is induced between the second slot patterns of the conductive patterns adjacent in the electric field direction, among the plurality of conductive patterns,
a first capacitance Cp1 is induced in the first slot pattern,
a second capacitance Cp2 is induced in the second slot pattern, and
a resonant frequency fr of the AMC is set to
$${f}_{r} = \frac{1}{2 π \sqrt{( L ( {C}_{g +} {C}_{p 1 +} {C}_{p 2} )}} .$$

18. The electronic device of claim 16, wherein one surface of the first dielectric substrate is arranged to oppose the second dielectric substrate on which the conductive surface is formed,
another surface of the first dielectric substrate is arranged to oppose the open area of the waveguide, and
a third ground pattern formed on the another surface of the first dielectric substrate has a third open area formed to correspond to the open area of the waveguide.

19. The electronic device of claim 18, wherein a first length of the open area of the waveguide in the one axial direction, a second length of the second open area of the transmission line in the one axial direction, and a third length of the third open area of the first dielectric substrate in the one axial direction are formed identically,
a first width of the open area of the waveguide in the another axial direction, a second width of the second open area of the transmission line in the another axial direction, and a third width of the third open area of the first dielectric substrate in the another axial direction are formed identically, and
the one axial direction and the another axial direction are formed in an electric field direction and a magnetic field direction of a signal transmitted through the waveguide.

20. The electronic device of claim 16, wherein the unit cell of each of the plurality of conductive patterns comprises:
a conductive pattern formed in a circular shape to correspond to a circular shape of the vertical via constituting the via structure;
a first slot pattern formed on the conductive pattern to be symmetrical to the vertical via in the one axial direction; and
a second slot pattern formed on the conductive pattern to be symmetrical to the vertical via in the another axis direction,
the first slot pattern comprises a first sub-slot and a second sub-slot formed in upper and lower regions of the vertical via, and
the second slot pattern comprises a third sub-slot and a fourth sub-slot formed in upper and lower regions of the vertical via.
